(19) United States
(12) Patent Application Publication
(10) Pub. No.: US 2025/0215309 A1
(43) Pub. Date: Jul. 3, 2025

(54) SILICA COMPOSITE MICROPARTICLES COMPRISING NANOSTRUCTURES

(71) Applicant: Shoei Chemical Inc., Tokyo (JP)

(72) Inventors: ASHAVANI KUMAR, San Jose, CA (US); CHARLES HOTZ, SAN RAFAEL, CA (US); JAY SEIJI YAMANAGA, CAMPBELL, CA (US); DAVID OLMEIJER, SAN FRANCISCO, CA (US)

(21) Appl. No.: 18/850,506

(22) PCT Filed: Mar. 24, 2023
(86) PCT No.: PCT/US2023/016304

§ 371 Date: Sep. 24, 2024

Related U.S. Application Data
(60) Provisional application No. 63/323,580, filed on Mar. 25, 2022.

(51) Int. Cl. C09K 11/02; B82Y 20/00; B82Y 40/00; C08J 5/18; C08K 9/02; C09K 11/88; G02B 1/14

(52) U.S. Cl. CPC C09K 11/025; C08J 5/18; C08K 9/02; C09K 11/883; G02B 1/14; B82Y 20/00; B82Y 40/00; C08K 2201/011

(57) ABSTRACT

The present invention is in the field of nanostructures. Provided herein are microparticles comprising nanostructures and silica. Also provided herein are methods of preparing the microparticles, films comprising the microparticles, and devices comprising the microparticles. Also provided herein are display backlighting units (BLUs) that do not comprise a barrier layer.

### BACKGROUND

### Field of the Invention

The invention is in the field of nanostructures. Provided are silica composite microparticles comprising nanostructures. Also provided are methods of preparing the microparticles, films comprising the microparticles, and devices comprising the microparticles. Also provided are display backlighting units (BLUs) that do not comprise a barrier layer.

### Background of the Invention

Quantum Dot Enhancement films (QDEF) are multilayer structures consisting of a nanostructure embedded in a polymer resin sandwiched between one or more barrier layers. The barrier layers provide stability in operating conditions such as flux, temperature, and humidity. However, the barrier layers impose additional cost to the product.

A need exists for films comprising nanostructure compositions that have improved stability without the need for barrier layers.

### SUMMARY

Provided is a unique approach to providing QDEF films that do not require barrier layers and that contain nanostructure-containing silica microparticles. The nanostructure-containing silica microparticles may be embedded in any optical grade polymer film by extrusion or similar process and the film can be used as QDEF in display devices. Since the particles are stable, and a barrier layer is not required, the cost of devices containing the microparticles is reduced. In some embodiments, the QDEF is as shown in FIG. 1.

The present disclosure provides compositions comprising a population of nanostructures comprising a nanocrystal core, wherein the nanostructures are embedded in silica microparticles.

In some embodiments, the nanocrystal core is selected from the group consisting of Si, Ge, Sn, Se, Te, B, C, P, BN, BP, BAS, AlN, AlP, AlAs, AlSb, GaN, GaP, GaAs, GaSb, InN, InP, InAs, InSb, ZnO, ZnS, ZnSe, ZnTe, CdS, CdSe, CdSeZn, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, Al₂CO, AgInGaS and combinations thereof.

In some embodiments, the nanocrystal core comprises InP.

In some embodiments, the nanocrystal core comprises CdSe.

In some embodiments, the nanocrystal core comprises at least one shell.

In some embodiments, the at least one shell is ZnSe.

In some embodiments, the at least one shell is ZnS.

In some embodiments, the nanostructures comprise silver, indium, gallium, and sulfur (AIGS).

In some embodiments, the silica microparticles have diameters of about 1 μm to about 20 μm.

In some embodiments, the silica microparticles have a mean particle size of about 2 μm to about 12 μm.

The present disclosure also provides methods of making the compositions described herein, the methods comprising:
(a) admixing the nanostructures and a metal or ammonium silicate in water;
(b) adding the admixture obtained in (a) to a solution comprising a nonionic surfactant in a nonpolar aprotic solvent and mixing to give a first microemulsion;
(c) removing water from the first microemulsion obtained in (b);
(d) admixing acetic acid, a nonionic surfactant and a nonpolar aprotic solvent to give a second microemulsion;
(e) admixing the first and second microemulsions to give silica microparticles comprising the nanostructures; and
(f) isolating the microparticles obtained in (e).

In some embodiments, the first and second microemulsions are passed through a filter with pores of less than 10 μm prior to admixing in (e).

In some embodiments, the non-polar aprotic solvent comprises 1-octadecene, 1-hexadecene, 1-eicosene, eicosane, octadecane, hexadecane, tetradecane, squalene, or squalane, or combinations thereof.

In some embodiments, the non-polar aprotic solvent comprises 1-octadecene.

The present disclosure also provides nanostructure films comprising:
(a) a composition described herein; and
(b) at least one organic resin.

In some embodiments, the microparticles are embedded in at least one organic resin that forms the film.

In some embodiments, the film is cured.

In some embodiments, the film is formed by extrusion.

In some embodiments, the film does not comprise a barrier layer adjacent to the film that has low oxygen and moisture permeability.

The present disclosure also provides nanostructure molded articles comprising:
(a) a first conductive layer;
(b) a second conductive layer; and
(c) a nanostructure layer between the first conductive layer and the second conductive layer, wherein the nanostructure layer comprises a composition described herein.

In some embodiments, the nanostructure molded article does not comprise a barrier layer, adjacent to the film, that has low oxygen and moisture permeability.

The present disclosure also provides display devices comprising a composition described herein.

In some embodiments, the microparticles are embedded in a matrix that forms a film within the display device.

In some embodiments, the film is disposed on a light guide plate.

In some embodiments, the display device does not comprise a barrier layer, adjacent to the film, that has low oxygen and moisture permeability.

The present disclosure also provides display backlighting units (BLU), comprising:
(a) at least one primary light source that emits primary light;
(b) a light guide plate (LGP) optically coupled to the at least one primary light source, whereby the primary light is transmitted uniformly through the LGP; and
(c) an extruded film disposed over the LGP, wherein the primary light transmits uniformly through the LGP and into the extruded film;
(d) wherein the extruded film is not directly physically coupled to the LGP and comprises one or more populations of nanostructures configured to emit secondary light, wherein at least a portion of the primary light is absorbed by the nanostructures and reemitted by the nanostructures as the secondary light, and wherein the BLU does not comprise a barrier layer.

In some embodiments, the nanostructures comprise a nanocrystal core selected from the group consisting of Si, Ge, Sn, Se, Te, B, C, P, BN, BP, BAs, AlN, AlP, AlAs, AlSb, GaN, GaP, GaAs, GaSb, InN, InP, InAs, InSb, ZnO, ZnS, ZnSe, ZnTe, CdS, CdSe, CdSeZn, CdTe, HgS, HgSe, HgTe, Bes, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, Al₂CO, AgInGaS and combinations thereof.

In some embodiments, the nanocrystal core comprises InP.

In some embodiments, the nanocrystal core comprises CdSe.

In some embodiments, the nanocrystal core comprises at least one shell.

In some embodiments, the at least one shell is ZnSe.

In some embodiments, the at least one shell is ZnS.

In some embodiments, the nanostructures comprise silver, indium, gallium, and sulfur (AIGS).

In some embodiments, the extruded film comprises at least one organic resin.

In some embodiments, the at least one organic resin is poly(methyl methacrylate) (PMMA), polyethylene terephthalate (PET), or a combination thereof.

In some embodiments, the one or more populations of nanostructures are encapsulated by an inorganic material.

In some embodiments, the inorganic material comprises silica microparticles.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a schematic depicting an extruded polymer film 101 with embedded silica microparticles 102 containing nanostructures 103.

FIG. 2 is a process flow diagram for the synthesis of nanostructure-containing calcium silicate microparticles.

FIGS. 3A-3C are scanning electron microscopy (SEM) images of nanostructure-containing calcium silicate microparticles at different magnifications.

FIG. 4 is a graph showing the particle size distribution of nanostructure-containing calcium silicate microparticles from FIGS. 3A-3C.

FIGS. 5A-5D are graphs showing the emitted power of a quantum dot enhancement film (QDEF) at 50° C. under high flux (1, 10 and 68X, FIG. 5A), under accelerating conditions at 80° C. under high flux (FIG. 5B), at 85° C. under dark storage (FIG. 5C), and storage at 60° C. and 90% relative humidity.

FIG. 6 is a process flow diagram for the synthesis of nanostructure-containing calcium silicate microparticles.

FIGS. 7A-7B are SEM images of nanostructure-containing calcium silicate microparticles at different magnifications and the particle size distribution (FIG. 7C).

FIG. 8 is a process flow diagram for the synthesis of nanostructure-containing silica microparticles.

FIGS. 9A-9C are SEM images of nanostructure-containing silica microparticles at different magnifications and the particle size distribution (FIG. 9D).

FIGS. 10A-10C are SEM images of nanostructure-containing silica microparticles at different magnifications and the particle size distribution (FIG. 10D).

FIGS. 11A-11C are SEM images of a cross-sectioned extruded poly(methyl methacrylate) (PMMA) film containing nanostructure-containing silica microparticles, showing the distribution and stability of the particles after the extrusion process.

FIGS. 12A-12D are graphs showing the emitted power of a quantum dot enhancement film (QDEF) under 85° C. under dark storage (FIG. 12A), under 1 & 10X flux at 50° C. (FIG. 12B), under storage at 60° C./90% relative humidity (FIG. 12C), and under 1 & 10X flux at 80° C.

FIG. 13 is a process flow diagram for the synthesis of nanostructure-containing calcium silicate microparticles.

FIGS. 14A-14C are SEM images of nanostructure-containing calcium silicate microparticles at different magnifications and the particle size distribution (FIG. 14D).

FIGS. 15A-15D are graphs showing the emitted power of a QDEF under 1, 10 & 68X flux at 50° C. (FIG. 15A), QDEF under 1 & 10X flux at 80° C. (FIG. 15B), under dark storage at 85° C. (FIG. 15C), and under storage at 60° C./90% relative humidity (FIG. 15D).

FIGS. 16A-16B are SEM images of nanostructure-containing silica microparticles obtained by reaction of ammonium silicate with acetic acid as described in Example 4. FIG. 16C is a table showing the chemical composition of the silica microparticles, showing that they consist of CdS/ZnSe nanostructures and silica.

FIGS. 17A-17B are SEM images of nanostructure-containing silica microparticles obtained by the emulsion process described in Example 2. FIG. 17C is a table showing the presence of silicon, calcium, cadmium, zinc, sulfur and selenium in the silica microparticles, showing that they consist of CdS/ZnSe nanostructures and calcium silicate.

FIGS. 18A-18B are SEM images of nanostructure-containing silica microparticles obtained by the emulsion process described in Example 2 with lithium silicate starting material.

FIG. 18C is a table showing the chemical composition of the silica microparticles, showing that they consist of CdS/ZnSe nanostructures and calcium silicate.

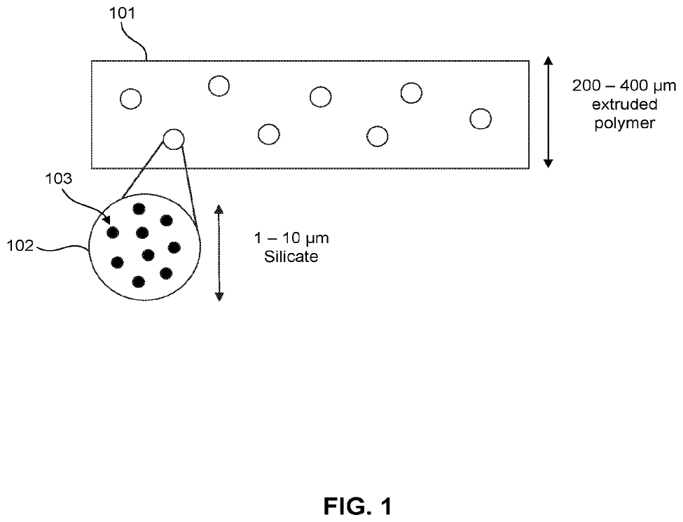

### DETAILED DESCRIPTION

Unless defined otherwise, all technical and scientific terms used herein have the same meaning as commonly understood by one of ordinary skill in the art to which the invention pertains. The following definitions supplement those in the art and are directed to the current application and are not to be imputed to any related or unrelated case, e.g., to any commonly owned patent or application. Although any methods and materials similar or equivalent to those described herein can be used in practice for testing, the preferred materials and methods are described herein. Accordingly, the terminology used herein is for the purpose of describing particular embodiments only, and is not intended to be limiting.

As used in this specification and the appended claims, the singular forms “a,” “an,” and “the” include plural referents unless the context clearly dictates otherwise. Thus, for example, reference to “a nanostructure” includes a plurality of such nanostructures, and the like.

The term “about” as used herein indicates the value of a given quantity varies by +10% of the value. For example, “about 100 nm” encompasses a range of sizes from 90 nm to 110 nm, inclusive.

A “nanostructure” is a structure having at least one region or characteristic dimension with a dimension of less than about 500 nm. In some embodiments, the nanostructure has a dimension of less than about 200 nm, less than about 100 nm, less than about 50 nm, less than about 20 nm, or less than about 10 nm, e.g., 1-10 nm. Typically, the region or characteristic dimension will be along the smallest axis of the structure. Examples of such structures include nanowires, nanorods, nanotubes, branched nanostructures, nano tetrapods, tripods, bipods, nanocrystals, nanodots, quantum dots, nanoparticles, and the like. Nanostructures can be, e.g., substantially crystalline, substantially monocrystalline, polycrystalline, amorphous, or a combination thereof. In some embodiments, each of the three dimensions of the nanostructure has a dimension of less than about 500 nm, less than about 200 nm, less than about 100 nm, less than about 50 nm, less than about 20 nm, or less than about 10 nm.

The term “heterostructure” when used with reference to nanostructures refers to nanostructures characterized by at least two different and/or distinguishable material types. Typically, one region of the nanostructure comprises a first material type, while a second region of the nanostructure comprises a second material type. In certain embodiments, the nanostructure comprises a core of a first material and at least one shell of a second (or third etc.) material, where the different material types are distributed radially about the long axis of a nanowire, a long axis of an arm of a branched nanowire, or the center of a nanocrystal, for example. A shell can but need not completely cover the adjacent materials to be considered a shell or for the nanostructure to be considered a heterostructure; for example, a nanocrystal characterized by a core of one material covered with small islands of a second material is a heterostructure. In other embodiments, the different material types are distributed at different locations within the nanostructure; e.g., along the major (long) axis of a nanowire or along a long axis of an arm of a branched nanowire. Different regions within a heterostructure can comprise entirely different materials, or the different regions can comprise a base material (e.g., silicon) having different dopants or different concentrations of the same dopant.

As used herein, the “diameter” of a nanostructure refers to the diameter of a cross-section normal to a first axis of the nanostructure, where the first axis has the greatest difference in length with respect to the second and third axes (the second and third axes are the two axes whose lengths most nearly equal each other). The first axis is not necessarily the longest axis of the nanostructure; e.g., for a disk-shaped nanostructure, the cross-section would be a substantially circular cross-section normal to the short longitudinal axis of the disk. Where the cross-section is not circular, the diameter is the average of the major and minor axes of that cross-section. For an elongated or high aspect ratio nanostructure, such as a nanowire, the diameter is measured across a cross-section perpendicular to the longest axis of the nanowire. For a spherical nanostructure, the diameter is measured from one side to the other through the center of the sphere.

The terms “crystalline” or “substantially crystalline,” when used with respect to nanostructures, refer to the fact that the nanostructures typically exhibit long-range ordering across one or more dimensions of the structure. It will be understood by one of skill in the art that the term “long-range ordering” will depend on the absolute size of the specific nanostructures, as ordering for a single crystal cannot extend beyond the boundaries of the crystal. In this case, “long-range ordering” will mean substantial order across at least the majority of the dimensions of the nanostructure. In some instances, a nanostructure can bear an oxide or other coating, or can be comprised of a core and at least one shell. In such instances it will be appreciated that the oxide, shell(s), or other coating can but need not exhibit such ordering (e.g., it can be amorphous, polycrystalline, or otherwise). In such instances, the phrase “crystalline,” “substantially crystalline,” “substantially monocrystalline,” or “monocrystalline” refers to the central core of the nanostructure (excluding the coating layers or shells). The terms “crystalline” or “substantially crystalline” as used herein are intended to also encompass structures comprising various defects, stacking faults, atomic substitutions, and the like, as long as the structure exhibits substantial long-range ordering (e.g., order over at least about 80% of the length of at least one axis of the nanostructure or its core). In addition, it will be appreciated that the interface between a core and the outside of a nanostructure or between a core and an adjacent shell or between a shell and a second adjacent shell may contain non-crystalline regions and may even be amorphous. This does not prevent the nanostructure from being crystalline or substantially crystalline as defined herein.

The term “monocrystalline” when used with respect to a nanostructure indicates that the nanostructure is substantially crystalline and comprises substantially a single crystal. When used with respect to a nanostructure heterostructure comprising a core and one or more shells, “monocrystalline” indicates that the core is substantially crystalline and comprises substantially a single crystal.

A “nanocrystal” is a nanostructure that is substantially monocrystalline. A nanocrystal thus has at least one region or characteristic dimension with a dimension of less than about 500 nm. In some embodiments, the nanocrystal has a dimension of less than about 200 nm, less than about 100 nm, less than about 50 nm, less than about 20 nm, or less than about 10 nm, e.g., 1-10 nm. The term “nanocrystal” is intended to encompass substantially monocrystalline nanostructures comprising various defects, stacking faults, atomic substitutions, and the like, as well as substantially monocrystalline nanostructures without such defects, faults, or substitutions. In the case of nanocrystal heterostructures comprising a core and one or more shells, the core of the nanocrystal is typically substantially monocrystalline, but the shell(s) need not be. In some embodiments, each of the three dimensions of the nanocrystal has a dimension of less than about 500 nm, less than about 200 nm, less than about 100 nm, less than about 50 nm, less than about 20 nm, or less than about 10 nm.

The term “quantum dot” (or “dot”) refers to a nanocrystal that exhibits quantum confinement or exciton confinement. Quantum dots can be substantially homogenous in material properties, or in certain embodiments, can be heterogeneous, e.g., including a core and at least one shell. The optical properties of quantum dots can be influenced by their particle size, chemical composition, and/or surface composition, and can be determined by suitable optical testing available in the art. The ability to tailor the nanocrystal size, e.g., in the range between about 1 nm and about 15 nm, enables photoemission coverage in the entire optical spectrum to offer great versatility in color rendering.

A “ligand” is a molecule capable of interacting (whether weakly or strongly) with one or more facets of a nanostructure, e.g., through covalent, ionic, van der Waals, or other molecular interactions with the surface of the nanostructure.

“Photoluminescence quantum yield” (PLQY) is the ratio of photons emitted to photons absorbed, e.g., by a nanostructure or population of nanostructures. As known in the art, quantum yield is typically determined by a comparative method using well-characterized standard samples with known quantum yield values.

Peak emission wavelength” (PWL) is the wavelength where the radiometric emission spectrum of the light source reaches its maximum.

As used herein, the term “shell” refers to material deposited onto the core or onto previously deposited shells of the same or different composition and that result from a single act of deposition of the shell material. The exact shell thickness depends on the material as well as the precursor input and conversion and can be reported in nanometers or monolayers. As used herein, “target shell thickness” refers to the intended shell thickness used for calculation of the required precursor amount. As used herein, “actual shell thickness” refers to the actually deposited amount of shell material after the synthesis and can be measured by methods known in the art. By way of example, actual shell thickness can be measured by comparing particle diameters determined from transmission electron microscopy (TEM) images of nanocrystals before and after a shell synthesis.

As used herein, the term “full width at half-maximum” (FWHM) is a measure of the size distribution of nanoparticles. The emission spectra of nanoparticles generally have the shape of a Gaussian curve. The width of the Gaussian curve is defined as the FWHM and gives an idea of the size distribution of the particles. A smaller FWHM corresponds to a narrower quantum dot nanocrystal size distribution. FWHM is also dependent upon the peak emission wavelength.

As used herein, the term “half width at half-maximum” (HWHM) is a measure of the size distribution of nanoparticles extracted from UV-vis spectroscopy curves. A HWHM on the low-energy side of the first exciton absorption peak can be used as a suitable indicator of the size distribution, with smaller HWHM values corresponding to narrower size distributions.

As used herein, a microparticle is a particle with a diameter of 100 μm or less. In some embodiments, a microparticle has a diameter of about 1 to about 20 μm. In some embodiments, a microparticle has a diameter of about 1 to about 15 μm. In some embodiments, a microparticle has a diameter of about 1 to about 12 μm. In some embodiments, a microparticle has a diameter of about 1, about 2, about 3, about 4, about 5, about 6, about 7, about 8, about 9, about 10, about 11, about 12, about 13, about 14, about 15, about 16, about 17, about 18 or about 20 μm. In some embodiments, the mean microparticle size is about 2 to about 12 μm. In some embodiments, the mean microparticle size is about 2, about 3, about 4, about 5, about 6, about 7, about 8, about 9, about 10, about 11, about 12 μm.

### Microparticle Compositions

In some embodiments, the microparticle composition comprises one or more nanostructures and silica. In some embodiments, the microparticle composition may further comprise a metal silicate such as lithium or calcium silicate. In other embodiments, the microparticle may comprise an ammonium silicate.

### Methods of Making Microparticle Compositions

Provided is a method of making the microparticle compositions comprising calcium silicate as described herein, comprising:
(a) admixing the nanostructures and a metal or ammonium silicate in water;
(b) adding the admixture obtained in (a) to a mixture of a nonpolar aprotic solvent and a non-ionic surfactant, and mixing the resulting composition to give a first microemulsion;
(c) filtering the admixture obtained in (b);
(d) removing water from the first microemulsion obtained in (c) to give microparticles;
(e) isolating the microparticles obtained in (d);
(f) admixing the isolated microparticles obtained in (e) with a calcium halide solution to give microparticles comprising calcium silicate; and
(g) isolating the microparticles comprising calcium silicate.

For example, in (a), 2 mL of aqueous dispersion of quantum dots (QDs) such as CdSe (9-10 wt % inorganic content)+3.4 mL of water are stirred. In some embodiments, the admixture further comprises 0.15 ml of (3-mercaptopropyl) trimethoxysilane (MPTMS). In some embodiments, the admixing in (a) is carried out at room temperature to 100° C. In other embodiments, the admixing in (a) is carried out at 50-90° C. In other embodiments, the admixing in (a) is carried out at 50, 55, 60, 65, 70, 75, 80, 85, or 90° C. In some embodiments, the admixture is stirred at 80° C. for 5 minutes. Then, a metal silicate solution (e.g., 2.8 mL of 25 wt. % solution of LiSil) is added with good stirring.

In (b), a non-ionic surfactant/nonpolar aprotic solvent mixture is added with good stirring. Examples of non-ionic surfactants include Span® 80 (sorbitan monooleate) (e.g., 16.5 ml of 1.3 wt % or Tween® (fatty acid esters of polyethoxy sorbitan). In some embodiments, the non-polar aprotic solvent comprises 1-octadecene, 1-hexadecene, 1-eicosene, eicosane, octadecane, hexadecane, tetradecane, squalene, or squalane, or combinations thereof. The solution becomes milky, indicating the formation of a microemulsion.

In (c), the admixture obtained in (b) is filtered, e.g., is passed through a micron filter for homogenization. In some embodiments, the filter contains 1-10 μm pores. In some embodiments, the pores are 1, 2, 3, 4, 5, 6, 7, 8, 9, or 10 μm in diameter. Homogenization can also be achieved by mechanical homogenizer.

In (d), water is removed from the microemulsion by heating and/or placing under reduced pressure. In some embodiments, the microemulsion is heated to 50-100° C. In some embodiments, the microemulsion is heated at 80° C. under vacuum. In some embodiments, the microemulsion is heated for about 10-15 min at 10 Torr vacuum.

In (e), the microparticles are isolated. In some embodiments, the microparticles are isolated, e.g., by centrifugation. In some embodiments, the microparticles are isolated by centrifugation at 3000-4000 rpm, e.g., for 5 minutes.

In (f), the isolated microparticles obtained in (e) are admixed with a calcium halide solution to give microparticles comprising calcium silicate. In some embodiments, the calcium halide is calcium chloride. In some embodiments, the microparticles are dispersed in 7 ml of 1M calcium chloride solution and stirred for 30 minutes at 60° C.

In (g), the microparticles comprising calcium silicate are isolated/purified by washing with a non-solvent. Examples of non-solvents include acetone and ethanol. In some embodiments, the microparticles containing calcium silicate are washed with two acetone and two ethanol washes.

In some embodiments, the microparticles containing calcium silicate are isolated by centrifugation and purified by washing with ethanol (e.g., 2 times).

In some embodiments, the resultant product is dried to make powder and dispersed in a carrier solvent. In some embodiments, this process yields ˜95% of calcium silicate particles/batch with ˜20 wt % QD loading.

Also provided is a method of making the silica microparticle compositions described herein, comprising:
(a) admixing the nanostructures and a metal or ammonium silicate in water;
(b) adding the admixture obtained in (a) to a nonpolar aprotic solvent and nonionic surfactant, and mixing the resulting composition to give a first microemulsion;
(c) removing water from the first microemulsion obtained in (b) and isolating the microparticles;
(d) admixing the microparticles obtained in (c) with acetic acid and a nonpolar aprotic solvent to give a second microemulsion;
(e) admixing the first and second microemulsions to give silica microparticles comprising the nanostructures; and
(f) isolating the silica microparticles obtained in (e).

In some embodiments, the first and second microemulsions are filtered prior to admixing in (c). In some embodiments, the first and second microemulsions are passed through a filter with pores of 1-10 μm prior to admixing in (e). In some embodiments, the first and second microemulsions are passed through a filter with pores of 5 μm or less prior to admixing in (e). In some embodiments, the first and second emulsions are filter through a filter with a pore of 1, 2, 3, 4, 5, 6, 7, 8, 9 or 10 μm.

In some embodiments, the non-polar aprotic solvent used in (b) and (d) are the same or different. In some embodiments, the non-polar aprotic solvent comprises 1-octadecene, 1-hexadecene, 1-eicosene, eicosane, octadecane, hexadecane, tetradecane, squalene, or squalane, or combinations thereof. In (b), examples of non-ionic surfactants include Span® 80 (e.g., 16.5 ml of 1.3 wt % or Tween®).

In some embodiments, the admixing in (a) is carried out at room temperature to 100° C. In other embodiments, the admixing in (a) is carried out at 50-90° C. In other embodiments, the admixing in (a) is carried out at 50, 55, 60, 65, 70, 75, 80, 85, or 90° C.

In some embodiments, the metal silicate is lithium, beryllium, sodium, or potassium silicate. In some embodiments, the ammonium silicate is NH₄⁺SiO₄⁻ or a mono-, di-, tri-, or tetra-C1-4 alkyl ammonium silicate.

In (e), the microparticles are isolated. In some embodiments, the microparticles are isolated, e.g., by centrifugation. In some embodiments, the microparticles are isolated by centrifugation at 3000-4000 rpm, e.g., for 5 minutes.

In (d), acetic acid and a non-polar aprotic solvent are admixed. In some embodiments, the acetic acid is glacial acetic acid. In other embodiments, the ratio of acetic acid to non-polar aprotic solvent may range from 5% to 95% wt/wt.

Also provided is a method of making the microparticle compositions comprising calcium silicate described herein, comprising:

A 16.5 ml of 3 wt % Span® 80/ODE solution was stirred at 600 rpm. 2.8 mL of 25 wt. % lithium silicate solution was added with good stirring. The resultant mixture become milky, indicate the formation of a microemulsion.

This solution was passed through a 6 μm filter for homogenization. This solution was called “Microemulsion 1”.

2 mL of aqueous dispersion of QD (9-10 wt % inorganic content)+3.4 mL of water+0.15 ml of MPTMS was stirred at 60° C. for 5 minutes.

27.5 ml of 3 wt % Span® 80/ODE solution was stirred at 600 rpm. The above QD solution was added drop-by-drop. The resultant mixture become milky, indicate the formation of a microemulsion.

This solution was also passed through the 6 μm filter for homogenization. This solution is called “Microemulsion 2”.

Microemulsion 1 and 2 were mixed and kept for 30 min under stirring conditions.

15 ml of 3 wt % Span® 80/ODE solution was stirred at 600 rpm. 3 ml of 2M calcium chloride solution was added drop-by-drop. The resultant mixture become milky, indicate the formation of a microemulsion.

This solution was passed through a 6-micron filter for homogenization. This solution is called Microemulsion 3.

Finally, microemulsion 3 was added into mixture of microemulsion 1 &2 and the resultant mixture was kept for 30 min under stirring for silicate precipitation

Finally, the particles were isolated by centrifugation and purified by acetone and ethanol wash. The silica particles containing calcium silicate are then dried and stored in a carrier solvent.

### Nanostructure Core

The nanostructures cores for use in the present invention can be produced from any suitable material, suitably an inorganic material, and more suitably an inorganic conductive or semiconductive material. Suitable semiconductor materials include any type of semiconductor, including Group II-VI, Group III-V, Group IV-VI, and Group IV semiconductors. Suitable semiconductor materials include, but are not limited to, Si, Ge, Sn, Se, Te, B, C (including diamond), P, BN, BP, BAs, AlN, A1P, AlAs, AlSb, GaN, GaP, GaAs, GaSb, InN, InP, InAs, InSb, ZnO, ZnS, ZnSe, ZnTe, CdS, CdSe, CdSeZn, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, Al₂CO, AgInGaS and combinations thereof.

The synthesis of Group II-VI nanostructures has been described in U.S. Pat. Nos. 6,225,198, 6,322,901, 6,207,229, 6,607,829, 6,861,155, 7,060,243, 7,125,605, 7,374,824, 7,566,476, 8,101,234, and 8,158,193 and in U.S. Patent Appl. Publication Nos. 2011/0262752 and 2011/0263062. In some embodiments, the core is a Group II-VI nanocrystal selected from the group consisting of ZnO, ZnSe, ZnS, ZnTe, CdO, CdSe, CdS, CdTe, HgO, HgSe, HgS, and HgTe. In some embodiments, the core is a nanocrystal selected from the group consisting of ZnSe, ZnS, CdSe, and CdS.

Although Group II-VI nanostructures such as CdSe and CdS quantum dots can exhibit desirable luminescence behavior, issues such as the toxicity of cadmium limit the applications for which such nanostructures can be used. Less toxic alternatives with favorable luminescence properties are thus highly desirable. Group III-V nanostructures in general and InP-based nanostructures in particular, offer the best known substitute for cadmium-based materials due to their compatible emission range.

Synthesis of InP-based nanostructures has been described, e.g., in Xie, R., et al., “Colloidal InP nanocrystals as efficient emitters covering blue to near-infrared,” J. Am. Chem. Soc. 129:15432-15433 (2007); Micic, O. I., et al., “Core-shell quantum dots of lattice-matched ZnCdSe₂ shells on InP cores: Experiment and theory,” J. Phys. Chem. B 104:12149-12156 (2000); Liu, Z., et al., “Coreduction colloidal synthesis of III-V nanocrystals: The case of InP,” Angew. Chem. Int. Ed. Engl. 47:3540-3542 (2008); Li, L. et al., “Economic synthesis of high quality InP nanocrystals using calcium phosphide as the phosphorus precursor,” Chem. Mater. 20:2621-2623 (2008); D. Battaglia and X. Peng, “Formation of high quality InP and InAs nanocrystals in a noncoordinating solvent,” Nano Letters 2:1027-1030 (2002); Kim, S., et al., “Highly luminescent InP/GaP/ZnS nanocrystals and their application to white light-emitting diodes,” J. Am. Chem. Soc. 134:3804-3809 (2012); Nann, T., et al., “Water splitting by visible light: A nanophotocathode for hydrogen production,” Angew. Chem. Int. Ed. 49:1574-1577 (2010); Borchert, H., et al., “Investigation of ZnS passivated InP nanocrystals by XPS,” Nano Letters 2:151-154 (2002); L. Li and P. Reiss, “One-pot synthesis of highly luminescent InP/ZnS nanocrystals without precursor injection,” J. Am. Chem. Soc. 130:11588-11589 (2008); Hussain, S., et al. “One-pot fabrication of high-quality InP/ZnS (core/shell) quantum dots and their application to cellular imaging,” Chemphyschem. 70:1466-1470 (2009); Xu, S., et al., “Rapid synthesis of high-quality InP nanocrystals,” J. Am. Chem. Soc. 725:1054-1055 (2006); Micic, O. I., et al., “Size-dependent spectroscopy of InP quantum dots,” J. Phys. Chem. B 707:4904-4912 (1997); Haubold, S., et al., “Strongly luminescent InP/ZnS core-shell nanoparticles,” Chemphyschem. 5:331-334 (2001); CrosGagneux, A., et al., “Surface chemistry of InP quantum dots: A comprehensive study,” J. Am. Chem. Soc. 132:18147-18157 (2010); Micic, O. I., et al., “Synthesis and characterization of InP, GaP, and GalnP2 quantum dots,” J. Phys. Chem. 99:1154-7159 (1995); Guzelian, A. A., et al., “Synthesis of size-selected, surface-passivated InP nanocrystals,” J. Phys. Chem. 100:1212-1219 (1996); Lucey, D. W., et al., “Monodispersed InP quantum dots prepared by colloidal chemistry in a non-coordinating solvent,” Chem. Mater. 17:3154-3162 (2005); Lim, J., et al., “InP@ZnSeS, core @composition gradient shell quantum dots with enhanced stability,” Chem. Mater. 23:4459-4463 (2011); and Zan, F., et al., “Experimental studies on blinking behavior of single InP/ZnS quantum dots: Effects of synthetic conditions and UV irradiation,” J. Phys. Chem. C 116:394-3950 (2012). However, such efforts have had only limited success in producing InP nanostructures with high quantum yields.

In some embodiments, the InP core is doped. In some embodiments, the dopant of the nanocrystal core comprises a metal, including one or more transition metals. In some embodiments, the dopant is a transition metal selected from the group consisting of Ti, Zr, Hf, V, Nb, Ta, Cr, Mo, W, Mn, Tc, Re, Fe, Ru, Os, Co, Rh, Ir, Ni, Pd, Pt, Cu, Ag, Au, and combinations thereof. In some embodiments, the dopant comprises a non-metal. In some embodiments, the dopant is ZnS, ZnSe, ZnTe, CdSe, CdS, CdTe, HgS, HgSe, HgTe, CuInS₂, CuInSe₂, AlN, AlP, AlAs, GaN, GaP, or GaAs.

In some embodiments, the core is purified before deposition of a shell. In some embodiments, the core is filtered to remove precipitate from the core solution.

In some embodiments, the diameter of the InP core is determined using quantum confinement. Quantum confinement in zero-dimensional nanocrystallites, such as quantum dots, arises from the spatial confinement of electrons within the crystallite boundary. Quantum confinement can be observed once the diameter of the material is of the same magnitude as the de Broglie wavelength of the wave function. The electronic and optical properties of nanoparticles deviate substantially from those of bulk materials. A particle behaves as if it were free when the confining dimension is large compared to the wavelength of the particle. During this state, the bandgap remains at its original energy due to a continuous energy state. However, as the confining dimension decreases and reaches a certain limit, typically in nanoscale, the energy spectrum becomes discrete. As a result, the bandgap becomes size-dependent.

In some embodiments, the nanostructures are free from cadmium. As used herein, the term “free of cadmium” is intended that the nanostructures contain less than 100 ppm by weight of cadmium. The Restriction of Hazardous Substances (RoHS) compliance definition requires that there must be no more than 0.01% (100 ppm) by weight of cadmium in the raw homogeneous precursor materials. The cadmium level in the Cd-free nanostructures of the present invention is limited by the trace metal concentration in the precursor materials. The trace metal (including cadmium) concentration in the precursor materials for the Cd-free nanostructures, can be measured by inductively coupled plasma mass spectroscopy (ICP-MS) analysis, and are on the parts per billion (ppb) level. In some embodiments, nanostructures that are “free of cadmium” contain less than about 50 ppm, less than about 20 ppm, less than about 10 ppm, or less than about 1 ppm of cadmium.

### Shells

In some embodiments, the nanostructure cores comprise one or more shells. Exemplary materials for preparing shells include, but are not limited to, Si, Ge, Sn, Se, Te, B, C (including diamond), P, Co, Au, BN, BP, BAs, AlN, AlP, AlAs, AlSb, GaN, GaP, GaAs, GaSb, InN, InP, InAs, InSb, GaSb, ZnO, ZnS, ZnSe, ZnTe, CdS, CdSe, CdSeZn, CdTe, HgS, HgSe, HgTe, BeS, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, Al₂CO, and combinations thereof.

In some embodiments, the shell is a mixture of at least two of a zinc source, a selenium source, a sulfur source, a tellurium source, and a cadmium source. In some embodiments, the shell is a mixture of two of a zinc source, a selenium source, a sulfur source, a tellurium source, and a cadmium source. In some embodiments, the shell is a mixture of three of a zinc source, a selenium source, a sulfur source, a tellurium source, and a cadmium source. In some embodiments, the shell is a mixture of: zinc and sulfur; zinc and selenium; zinc, sulfur, and selenium; zinc and tellurium; zinc, tellurium, and sulfur; zinc, tellurium, and selenium; zinc, cadmium, and sulfur; zinc, cadmium, and selenium; cadmium and sulfur; cadmium and selenium; cadmium, selenium, and sulfur; cadmium and zinc; cadmium, zinc, and sulfur; cadmium, zinc, and selenium; or cadmium, zinc, sulfur, and selenium. In some embodiments, the shell is a mixture of zinc and selenium. In some embodiments, the shell is a mixture of zinc and sulfur.

Exemplary core/shell luminescent nanostructures include, but are not limited to, (represented as core/shell) CdSe/ZnSe and InP/ZnSe.

In some embodiments, the shell comprises ZnSe. The thickness of the shell can be controlled by varying the amount of precursor provided. For a given shell thickness, at least one of the precursors is optionally provided in an amount whereby, when a growth reaction is substantially complete, a shell of a predetermined thickness is obtained. In some embodiments, the molar ratio of the zinc source and the selenium source is between about 0.01:1 and about 1:1.5, about 0.01:1 and about 1:1.25, about 0.01:1 and about 1:1, about 0.01:1 and about 1:0.75, about 0.01:1 and about 1:0.5, about 0.01:1 and about 1:0.25, about 0.01:1 and about 1:0.05, about 0.05:1 and about 1:1.5, about 0.05:1 and about 1:1.25, about 0.05:1 and about 1:1, about 0.05:1 and about 1:0.75, about 0.05:1 and about 1:0.5, about 0.05:1 and about 1:0.25, about 0.25:1 and about 1:1.5, about 0.25:1 and about 1:1.25, about 0.25:1 and about 1:1, about 0.25:1 and about 1:0.75, about 0.25:1 and about 1:0.5, about 0.5:1 and about 1:1.5, about 0.5:1 and about 1:1.25, about 0.5:1 and about 1:1, about 0.5:1 and about 1:0.75, about 0.75:1 and about 1:1.5, about 0.75:1 and about 1:1.25, about 0.75:1 and about 1:1, about 1:1 and about 1:1.5, about 1:1 and about 1:1.25, or about 1:1.25 and about 1:1.5.

The thickness of the ZnSe shell layer can be controlled by varying the amount of zinc and selenium sources provided and/or by use of longer reaction times and/or higher temperatures. At least one of the sources is optionally provided in an amount whereby, when a growth reaction is substantially complete, a layer of a predetermined thickness is obtained.

The thickness of the ZnSe thin shell can be determined using techniques known to those of skill in the art. In some embodiments, the thickness of the inner thin shell is determined by comparing the average diameter of the nanostructure before and after the addition of the inner thin shell. In some embodiments, the average diameter of the nanostructure before and after the addition of the inner thin shell is determined by TEM. In some embodiments, the ZnSe shell has a thickness of between about 0.01 nm and about 0.35 nm, about 0.01 nm and about 0.3 nm, about 0.01 nm and about 0.25 nm, about 0.01 nm and about 0.2 nm, about 0.01 nm and about 0.1 nm, about 0.01 nm and about 0.05 nm, about 0.05 nm and about 0.35 nm, about 0.05 nm and about 0.3 nm, about 0.05 nm and about 0.25 nm, about 0.05 nm and about 0.2 nm, about 0.05 nm and about 0.1 nm, about 0.1 nm and about 0.35 nm, about 0.1 nm and about 0.3 nm, about 0.1 nm and about 0.25 nm, about 0.1 nm and about 0.2 nm, about 0.2 nm and about 0.35 nm, about 0.2 nm and about 0.3 nm, about 0.2 nm and about 0.25 nm, about 0.25 nm and about 0.35 nm, about 0.25 nm and about 0.3 nm, or about 0.3 nm and about 0.35 nm.

In some embodiments, the zinc source is a dialkyl zinc compound. In some embodiments, the zinc source is a zinc carboxylate. In some embodiments, the zinc source is diethylzinc, dimethylzinc, zinc acetate, zinc acetylacetonate, zinc iodide, zinc bromide, zinc chloride, zinc fluoride, zinc carbonate, zinc cyanide, zinc nitrate, zinc oleate, zinc oxide, zinc peroxide, zinc perchlorate, zinc sulfate, zinc hexanoate, zinc octanoate, zinc laurate, zinc myristate, zinc palmitate, zinc stearate, zinc dithiocarbamate, or mixtures thereof. In some embodiments, the zinc source is zinc oleate, zinc hexanoate, zinc octanoate, zinc laurate, zinc myristate, zinc palmitate, zinc stearate, zinc dithiocarbamate, or mixtures thereof. In some embodiments, the zinc source is zinc oleate.

In some embodiments, the selenium source is an alkyl-substituted selenourea. In some embodiments, the selenium source is a phosphine selenide. In some embodiments, the selenium source is selected from trioctylphosphine selenide, tri (n-butyl)phosphine selenide, tri (sec-butyl)phosphine selenide, tri (tert-butyl)phosphine selenide, trimethylphosphine selenide, triphenylphosphine selenide, diphenylphosphine selenide, phenylphosphine selenide, tricyclohexylphosphine selenide, cyclohexylphosphine selenide, 1-octaneselenol, 1-dodecaneselenol, selenophenol, elemental selenium, hydrogen selenide, bis(trimethylsilyl) selenide, selenourea, and mixtures thereof. In some embodiments, the selenium source is tri (n-butyl)phosphine selenide, tri (sec-butyl)phosphine selenide, or tri (tert-butyl)phosphine selenide. In some embodiments, the selenium source is trioctylphosphine selenide.

In some embodiments, the ZnSe shell is synthesized in the presence of at least one nanostructure ligand. Ligands can, e.g., enhance the miscibility of nanostructures in solvents or polymers (allowing the nanostructures to be distributed throughout a composition such that the nanostructures do not aggregate together), increase quantum yield of nanostructures, and/or preserve nanostructure luminescence (e.g., when the nanostructures are incorporated into a matrix). In some embodiments, the ligand(s) for the InP core synthesis and for the shell synthesis are the same. In some embodiments, the ligand(s) for the core synthesis and for the shell synthesis are different. Following synthesis, any ligand on the surface of the nanostructures can be exchanged for a different ligand with other desirable properties. Examples of ligands are disclosed in U.S. Pat. Nos. 7,572,395, 8,143,703, 8,425,803, 8,563,133, 8,916,064, 9,005,480, 9,139,770, and 9,169,435, and in U.S. Patent Application Publication No. 2008/0118755.

Ligands suitable for the synthesis of a shell are known by those of skill in the art. In some embodiments, the ligand is a fatty acid selected from the group consisting of lauric acid, caproic acid, myristic acid, palmitic acid, stearic acid, and oleic acid. In some embodiments, the ligand is an organic phosphine or an organic phosphine oxide selected from trioctylphosphine oxide (TOPO), trioctylphosphine (TOP), diphenylphosphine (DPP), triphenylphosphine oxide, and tributylphosphine oxide. In some embodiments, the ligand is an amine selected from the group consisting of dodecylamine, oleylamine, hexadecylamine, dioctylamine, and octadecylamine. In some embodiments, the ligand is oleic acid.

In some embodiments, the nanostructure composition comprises InP/ZnSe/ZnS core-shell nanostructures, wherein the thickness of at least one of the ZnSe and ZnS shells is between 0.7 nm and 3.5 nm, wherein the nanostructures exhibit a photoluminescence quantum yield of 60-99%, wherein the nanostructures exhibit a full width half-maximum of 35 nm to 45 nm; and wherein the nanostructures exhibit an OD₄₅₀/peak of about 1.0 to about 3.0. Such nanostructures and methods of making are disclosed in U.S. Appl. Publ. Nos. 2017/0306227 and 20180199007.

In some embodiments, the nanostructures comprise a core comprising indium phosphide and at least two shells, wherein at least one of the shells comprises zinc, wherein the nanostructure displays a photoluminescence quantum yield between about 94% and about 100%, and a wherein the nanostructure has a full width at half-maximum of less than 45 nm. In some embodiments, the nanostructures are InP/ZnSe/ZnS nanostructures. Such nanostructures and methods of making are disclosed in U.S. Appl. Publ. No. 2020/0325396.

In some embodiments, the nanostructure composition comprises core-shell nanostructures that have been surface treated with zinc acetate and zinc fluoride. In some embodiments, the present disclosure provides a nanostructure composition comprising InP/ZnSe core-shell nanostructures. In some embodiments, the ZnSe shell has a thickness of between about 0.01 nm and about 5 nm. In some embodiments, the nanostructure is a quantum dot. Such nanostructures and methods for making are disclosed in U.S. Appl. Publ. No. 20210013377.

In some embodiments, the nanostructure composition comprises ZnSe₁₋ₓTeₓ alloy nanocrystals with one or more shell layers, wherein 0>X>1. In some embodiments, nanostructures comprise a core surrounded by at least one shell, wherein the core comprises ZnSe₁₋ₓTeₓ, wherein 0<x<1, wherein the at least one shell is selected from the group consisting of ZnS, ZnSe, ZnTe, and alloys thereof, and wherein the full width at half-maximum (FWHM) of the nanostructure is about 20 nm to about 30 nm. Such nanostructures and methods of making are disclosed in U.S. Appl. Publ. No. 20210047563.

In some embodiments, nanostructures comprise a nanocrystal core and at least one shell, wherein at least one shell comprises at least one metal fluoride of formula (I): MF₄ (I) wherein: M=Zr, Hf, or Ti. In some embodiments, the nanostructures comprise: (a) a core comprising ZnSe, at least one shell comprising ZnS, and at least one shell comprising HfF₄; or (b) a core comprising ZnSe₁₋ₓTeₓ, wherein 0≤x≤1, at least one shell comprising ZnSe, and at least one shell comprising ZnS, and at least one shell comprising HfF₄. Such nanostructures and methods of making are disclosed in U.S. Appl. Publ. No. 2021/0277307.

In some embodiments, the nanostructure comprises a core surrounded by at least one shell, wherein the core comprises ZnSe₁₋ₓTeₓ, wherein 0<x<1, wherein the at least one shell comprises ZnS or ZnSe, and wherein the full width at half-maximum (FWHM) of the nanostructure is between about 10 nm and about 30 nm. In some embodiments, the nanostructures are ZnSe₁₋ₓTeₓ/ZnSe/ZnS core/shell nanostructures. Such nanostructures and methods of making are disclosed in U.S. Appl. Publ. No. 20190390109.

In some embodiments, the nanostructures comprise a nanocrystal core; and at least one shell disposed on the core, wherein at least one shell comprises ZnS and fluoride. In some embodiments, nanostructures comprise: a core comprising ZnSe, and at least one shell comprising ZnS and ZnF₂; a core comprising ZnSe, at least one shell comprising ZnSe, and at least one shell comprising ZnS and ZnF₂; a core comprising ZnSe₁₋ₓTeₓ, wherein 0≤x≤1, and at least one shell comprising ZnS and ZnF₂; or a core comprising ZnSe₁₋ₓTeₓ, wherein 0≤x≤1, at least one shell comprising ZnSe, and at least one shell comprising ZnS and ZnF₂. Such nanostructures and methods of making are disclosed in U.S. Appl. Publ. No. 2021/0009900.

In some embodiments, the nanostructures comprise at least one fluoride containing ligand bound to the surface of the nanostructure; wherein the fluoride containing ligand is selected from the group consisting of a fluorozincate, tetrafluoroborate, and hexafluorophosphate; or fluoride anions bound to the surface of the nanostructure; and wherein the nanostructure composition exhibits a photoluminescence quantum yield of between about 70% and about 90%. Such nanostructures and methods of making are disclosed in U.S. Appl. Publ. No. 2020/0299575.

In some embodiments, the nanostructures comprise Ag, In, Ga, and S (AIGS). In some embodiments, the nanostructures have a peak emission wavelength (PWL) in the range of 480-545 nm, wherein at least about 80% of the emission is band-edge emission, and wherein the nanostructures exhibit a quantum yield (QY) of 80-99.9%. Such nanostructures and methods of making are disclosed in U.S. Pat. No. 10,927,294.

### Films, Devices and Uses

A population of the microparticles are optionally embedded in a matrix that forms a film (e.g., an organic polymer, silicon-containing polymer, inorganic, glassy, and/or other matrix). This film may be used in production of a nanostructure phosphor, and/or incorporated into a device, e.g., an LED, backlight, downlight, or other display or lighting unit or an optical filter. Exemplary phosphors and lighting units can, e.g., generate a specific color light by incorporating a population of nanostructures with an emission maximum at or near the desired wavelength or a wide color gamut by incorporating two or more different populations of nanostructures having different emission maxima. A variety of suitable matrices are known in the art. See, e.g., U.S. Pat. No. 7,068,898 and U.S. Patent Application Publication Nos. 2010/0276638, 2007/0034833, and 2012/0113672. Exemplary nanostructure phosphor films, LEDs, backlighting units, etc. are described, e.g., in U.S. Patent Application Publications Nos. 2010/0276638, 2012/0113672, 2008/0237540, 2010/0110728, and 2010/0155749 and U.S. Pat. Nos. 7,374,807, 7,645,397, 6,501,091, and 6,803,719.

In some embodiments, the nanostructure films are used to form display devices. As used herein, a display device refers to any system with a lighting display. Such devices include, but are not limited to, devices encompassing a liquid crystal display (LCD), televisions, computers, mobile phones, smart phones, personal digital assistants (PDAs), gaming devices, electronic reading devices, digital cameras, and the like.

In some embodiments, the present disclosure provides a nanostructure molded article comprising:
(a) a first conductive layer;
(b) a second conductive layer; and
(c) a nanostructure layer between the first conductive layer and the second conductive layer, wherein the nanostructure layer comprises a population of silica microparticles comprising nanostructures embedded in a matrix.

In some embodiments, the present disclosure provides a nanostructure film comprising:
(a) at least one population of silica microparticles comprising a population of silica microparticles comprising nanostructures; and
(b) at least one organic resin.

As used herein, the term “embedded” is used to indicate that the microparticles are enclosed or encased within a matrix material. In some embodiments, the microparticles are uniformly distributed throughout the matrix material. In some embodiments, the microparticles are distributed according to an application-specific uniformity distribution function.

The matrix material can be any suitable host matrix material capable of housing the microparticles. Suitable matrix materials can be chemically and optically compatible with microparticles and any surrounding packaging materials or layers used in applying a nanostructure film to devices. Suitable matrix materials can include non-yellowing optical materials that are transparent to both the primary and secondary light, thereby allowing for both primary and secondary light to transmit through the matrix material. Matrix materials can include polymers and organic and inorganic oxides. Suitable polymers for use in the matrix material can be any polymer known to the ordinarily skilled artisan that can be used for such a purpose. The polymer can be substantially translucent or substantially transparent. Matrix materials can include, but not limited to, epoxies, acrylates, norbornene, polyethylene, poly(vinyl butyral): poly(vinyl acetate), polyurea, polyurethanes; silicones and silicone derivatives including, but not limited to, amino silicone (AMS), polyphenylmethylsiloxane, polyphenylalkylsiloxane, polydiphenylsiloxane, polydialkylsiloxane, silsesquioxanes, fluorinated silicones, and vinyl and hydride substituted silicones; acrylic polymers and copolymers formed from monomers including, but not limited to, methylmethacrylate, butylmethacrylate, and laurylmethacrylate; styrene-based polymers such as polystyrene, amino polystyrene (APS), and poly(acrylonitrile ethylene styrene) (AES); polymers that are crosslinked with bifunctional monomers, such as divinylbenzene; cross-linkers suitable for crosslinking ligand materials, epoxides that combine with ligand amines (e.g., APS or polyethylene imine ligand amines) to form epoxy, and the like.

In some embodiments, the matrix material further includes scattering microbeads such as TiO₂ microbeads, ZnS microbeads, or glass microbeads that can improve photo conversion efficiency of the nanostructure film. In some embodiments, the matrix material can include light blocking elements.

In some embodiments, the matrix material can have low oxygen and moisture permeability, exhibit high photo- and chemical-stability, exhibit favorable refractive indices, and adhere to outer surfaces of the nanostructures, thus providing an air-tight seal to protect the nanostructures. In another embodiment, the matrix material can be curable with UV or thermal curing methods to facilitate roll-to-roll processing.

In some embodiments, the nanostructure film further comprises one or more barrier layers immediately adjacent to the nanostructure film that have low oxygen and moisture permeability and protect the nanostructures from degradation. In other embodiments, the nanostructure film has at least one surface exposed to ambient conditions. In some embodiments, the nanostructure film does not comprise a barrier layer. This is possible as the silica-containing microparticles have low oxygen and moisture permeability. The use of the silica-containing microparticles eliminates the use of barrier layers, thus reducing the cost and complexity of a device comprising the nanostructure film.

In some embodiments, a nanostructure film can be formed by mixing the microparticles in a polymer (e.g., photoresist) and casting the microparticle-polymer mixture on a substrate, mixing the microparticles with monomers and polymerizing them together, mixing microparticles in a sol-gel to form an oxide, or any other method known to those skilled in the art.

In some embodiments, the formation of a nanostructure film can include a film extrusion process. The film extrusion process can include forming a homogenous mixture of matrix material and microparticles, introducing the homogenous mixture into a top mounted hopper that feeds into an extruder. In some embodiments, the homogenous mixture can be in the form of pellets. The film extrusion process can further include extruding a nanostructure film from a slot die and passing an extruded nanostructure film through chill rolls. In some embodiments, the extruded nanostructure film can have a thickness less than about 75 μm, for example, in a range from about 70 μm to about 40 μm, about 65 μm to about 40 μm, about 60 μm to about 40 μm, or about 50 μm to about 40 μm. In some embodiments, the nanostructure film has a thickness less than about 10 μm. In some embodiments, the formation of the nanostructure film can optionally include a secondary process followed by the film extrusion process. The secondary process can include a process such as co-extrusion, thermoforming, vacuum forming, plasma treatment, molding, and/or embossing to provide a texture to a top surface of the nanostructure film layer. The textured top surface nanostructure film can help to improve, for example defined optical diffusion property and/or defined angular optical emission property of the nanostructure film.

In some embodiments, the nanostructure composition is used to form a nanostructure molded article. In some embodiments, the nanostructure molded article is a liquid crystal display (LCD) or a light emitting diode (LED). In some embodiments, the nanostructure composition is used to form the emitting layer of an illumination device. The illumination device can be used in a wide variety of applications, such as flexible electronics, touchscreens, monitors, televisions, cellphones, and any other high definition displays. In some embodiments, the illumination device is a light emitting diode or a liquid crystal display. In some embodiments, the illumination device is a quantum dot light emitting diode (QLED). An example of a QLED is disclosed in U.S. patent application Ser. No. 15/824,701, which is incorporated herein by reference in its entirety. In some embodiments, the core-shell nanostructures are InP/ZnSe. In some embodiments, the molded article does not comprise a separate barrier layer to protect the nanostructures from oxygen and/or moisture.

In some embodiments, the present disclosure provides a light emitting diode comprising:
(a) a first conductive layer;
(b) a second conductive layer; and
(c) an emitting layer between the first conductive layer and the second conductive layer, wherein the emitting layer comprises (i) silica microparticles comprising at least one population of nanostructures.

In some embodiments, the core-shell nanostructures are CdSe/ZnSe or InP/ZnSe.

In some embodiments, the emitting layer is a nanostructure film.

In some embodiments, the light emitting diode comprises a first conductive layer, a second conductive layer, and an emitting layer, wherein the emitting layer is arranged between the first conductive layer and the second conductive layer. In some embodiments, the emitting layer is a thin film comprising silica microparticles comprising one or more populations of nanostructures.

In some embodiments, the light emitting diode comprises additional layers between the first conductive layer and the second conductive layer such as a hole injection layer, a hole transport layer, and an electron transport layer. In some embodiments, the hole injection layer, the hole transport layer, and the electron transport layer are thin films. In some embodiments, the layers are stacked on a substrate.

When voltage is applied to the first conductive layer and the second conductive layer, holes injected at the first conductive layer move to the emitting layer via the hole injection layer and/or the hole transport layer, and electrons injected from the second conductive layer move to the emitting layer via the electron transport layer. The holes and electrons recombine in the emitting layer to generate excitons. In some embodiments, the hole transport layer comprises poly[(9,9-dioctylfluorenyl-2,7-diyl)-co-(4,4′-(N-(4-sec-butylphenyl)diphenylamine)](TFB).

In some embodiments, the nanostructure film is incorporated into a glass LCD display device. A LCD display device can include a nanostructure film formed directly on a light guide plate (LGP) without necessitating an intermediate substrate or barrier layer. In some embodiments, a nanostructure film can be a thin film. In some embodiments, a nanostructure film can have a thickness of 500 μm or less, 100 μm or less, or 50 μm or less. In some embodiments, a nanostructure film is a thin film having a thickness of about 15 μm or less. In some embodiments, the core-shell nanostructures are CdSe/ZnSe or InP/ZnSe.

A LGP can include an optical cavity having one or more sides, including at least a top side, comprising glass. Glass provides excellent resistance to impurities including moisture and air. Moreover, glass can be formed as a thin substrate while maintaining structural rigidity. Therefore, a LGP can be formed at least partially of a glass surface to provide a substrate having sufficient barrier and structural properties.

In some embodiments, a nanostructure film can be formed on a LGP. In some embodiments, the nanostructure film comprises a population of silica microparticles comprising one or more populations of nanostructures embedded in a matrix material, such as a resin. A nanostructure film can be formed on a LGP by any method known in the art, such as wet coating, painting, spin coating, or screen printing. In some embodiments, the nanostructure film is formed by extrusion. After deposition, the resin of a nanostructure film can be cured. In some embodiments the resin of one or more nanostructure films can be partially cured, further processed and then finally cured. The nanostructure films can be deposited as one layer or as separate layers, and the separate layers can comprise varying properties. The width and height of the nanostructure films can be any desired dimensions, depending on the size of the viewing panel of the display device. For example, the nanostructure films can have a relatively small surface area in small display device embodiments such as watches and phones, or the nanostructure films can have a large surface area for large display device embodiments such as TVs and computer monitors.

In some embodiments, the present disclosure provides a display backlighting unit (BLU) comprising:
(a) at least one primary light source that emits primary light;
(b) a light guide plate (LGP) optically coupled to the at least one primary light source, whereby the primary light is transmitted uniformly through the LGP; and
(c) an extruded film disposed over the LGP, wherein the primary light transmits uniformly through the LGP and into the extruded film;
   wherein the extruded film is not directly physically coupled to the LGP and comprises one or more populations of nanostructures configured to emit secondary light, wherein at least a portion of the primary light is absorbed by the nanostructures and reemitted by the nanostructures as the secondary light, and wherein the BLU does not comprise a barrier layer.

In some embodiments, the one or more populations of nanostructures are encapsulated by an inorganic material. In some embodiments, the inorganic material comprises silica microparticles.

In some embodiments, an optically transparent substrate is formed on the nanostructure film by any method known in the art, such as vacuum deposition, vapor deposition, or the like. An optically transparent substrate can optionally be configured to provide environmental sealing to the underlying layers and/or structures of the nanostructure film. In some embodiments, light blocking elements can be included in the optically transparent substrate. In some embodiments, light blocking elements can be included in a second polarizing filter, which can be positioned between the substrate and the nanostructure film. In some embodiments, light blocking elements can be dichroic filters that, for example, can reflect the primary light (e.g., blue light, UV light, or combination of UV light and blue light) while transmitting the secondary light. Light blocking elements can include specific UV light filtering components to remove any unconverted UV light from the red and green subpixels, and/or the UV light from the blue sub-pixels.

In some embodiments, the nanostructure films are incorporated into display devices by “on-chip” placements. As used herein, “on-chip” refers to placing nanostructures into an LED cup. In some embodiments, the nanostructures are dissolved in a resin or a fluid to fill the LED cup. In some embodiments, the LED cup does not further comprise a barrier layer to protect the nanostructures from oxygen and/or moisture.

In some embodiments, the nanostructures are incorporated into display devices by “near-chip”placements. As used herein, “near-chip” refers to coating the top surface of the LED assembly with nanostructures such that the outgoing light passes through the nanostructure film.

In some embodiments, the present invention provides a display device comprising:
(a) a display panel to emit a first light;
(b) a backlight unit configured to provide the first light to the display panel; and
(c) a color filter comprising at least one pixel region comprising a color conversion layer.

In some embodiments, the color filter comprises at least 1, 2, 3, 4, 5, 6, 7, 8, 9, or 10 pixel regions. In some embodiments, when blue light is incident on the color filter, red light, white light, green light, and/or blue light may be respectively emitted through the pixel regions. In some embodiments, the color filter is described in U.S. Patent Appl. Publication No. 2017/153366.

In some embodiments, each pixel region includes a color conversion layer. In some embodiments, the color conversion layer comprises nanostructures described herein configured to convert incident light into light of a first color. In some embodiments, the color conversion layer comprises nanostructures described herein configured to convert incident light into blue light.

In some embodiments, the display device comprises 1, 2, 3, 4, 5, 6, 7, 8, 9, or 10 color conversion layers. In some embodiments, the display device comprises one color conversion layer comprising the nanostructures described herein. In some embodiments, the display device comprises two color conversion layers comprising the nanostructures described herein. In some embodiments, the display device comprises three color conversion layers comprising the nanostructures described herein. In some embodiments, the display device comprises four color conversion layers comprising the nanostructures described herein. In some embodiments, the display device comprises at least one red color conversion layer, at least one green color conversion layer, and at least one blue color conversion layer.

In some embodiments, the color conversion layer has a thickness between about 3 μm and about 10 μm, about 3 μm and about 8 μm, about 3 μm and about 6 μm, about 6 μm and about 10 μm, about 6 μm and about 8 μm, or about 8 μm and about 10 μm. In some embodiments, the color conversion layer has a thickness between about 3 μm and about 10 μm.

The nanostructure color conversion layer can be deposited by any suitable method known in the art, including but not limited to painting, spray coating, solvent spraying, wet coating, adhesive coating, spin coating, tape-coating, roll coating, flow coating, inkjet printing, photoresist patterning, drop casting, blade coating, mist deposition, or a combination thereof. In some embodiments, the nanostructure color conversion layer is deposited by photoresist patterning. In some embodiments, the nanostructure color conversion layer is deposited by inkjet printing.

### Inkjet Printing

The formation of thin films using dispersions of nanostructures in organic solvents is often achieved by coating techniques such as spin coating. However, these coating techniques are generally not suitable for the formation of thin films over a large area and do not provide a means to pattern the deposited layer and thus, are of limited use. Inkjet printing allows for precisely patterned placement of thin films on a large scale at low cost. Inkjet printing also allows for precise patterning of nanostructure layers, allows printing pixels of a display, and eliminates photopatterning. Thus, inkjet printing is very attractive for industrial application-particularly in display applications.

Solvents commonly used for inkjet printing are dipropylene glycol monomethyl ether acetate (DPMA), polyglycidyl methacrylate (PGMA), diethylene glycol monoethyl ether acetate (EDGAC), and propylene glycol methyl ether acetate (PGMEA). Volatile solvents are also frequently used in inkjet printing because they allow rapid drying. Volatile solvents include ethanol, methanol, 1-propanol, 2-propanol, acetone, methyl ethyl ketone, methyl isobutyl ketone, ethyl acetate, and tetrahydrofuran. Conventional nanostructures generally cannot be dissolved in these solvents. However, the increased hydrophilicity of the nanostructures comprising poly(alkylene oxide) ligands allows for increased solubility in these solvents.

In some embodiments, the microparticles described herein used for inkjet printing are dispersed in a solvent selected from DPMA, PGMA, EDGAC, PGMEA, ethanol, methanol, 1-propanol, 2-propanol, acetone, methyl ethyl ketone, methyl isobutyl ketone, ethyl acetate, tetrahydrofuran, chloroform, chlorobenzene, cyclohexane, hexane, heptane, octane, hexadecane, undecane, decane, dodecane, xylene, toluene, benzene, octadecane, tetradecane, butyl ether, or combinations thereof. In some embodiments, the nanostructures comprising a poly(alkylene oxide) ligands described herein used for inkjet printing are dispersed in a solvent selected from DPMA, PGMA, EDGAC, PGMEA, ethanol, methanol, 1-propanol, 2-propanol, acetone, methyl ethyl ketone, methyl isobutyl ketone, ethyl acetate, tetrahydrofuran, or combinations thereof.

In order to be applied by inkjet printing or microdispensing, the inkjet compositions comprising microparticles should be dispersed in a suitable solvent. The solvent must be able to disperse the microparticle composition and must not have any detrimental effect on the chosen print head.

In some embodiments, the inkjet composition further comprises one or more additional components such as surface-active compounds, lubricating agents, wetting agents, dispersing agents, hydrophobing agents, adhesive agents, flow improvers, defoaming agents, deaerators, diluents, auxiliaries, colorants, dyes, pigments, sensitizers, stabilizers, and inhibitors.

In some embodiments, the microparticle compositions described herein comprise by weight of the inkjet composition between about 0.01% and about 20%. In some embodiments, the nanostructures comprising poly(alkylene oxide) ligands comprise by weight of the inkjet composition between about 0.01% and about 20%, about 0.01% and about 15%, about 0.01% and about 10%, about 0.01% and about 5%, about 0.01% and about 2%, about 0.01% and about 1%, about 0.01% and about 0.1%, about 0.01% and about 0.05%, about 0.05% and about 20%, about 0.05% and about 15%, about 0.05% and about 10%, about 0.05% and about 5%, about 0.05% and about 2%, about 0.05% and about 1%, about 0.05% and about 0.1%, about 0.1% and about 20%, about 0.1% and about 15%, about 0.1% and about 10%, about 0.1% and about 5%, about 0.1% and about 2%, about 0.1% and about 1%, about 0.5% and about 20%, about 0.5% and about 15%, about 0.5% and about 10%, about 0.5% and about 5%, about 0.5% and about 2%, about 0.5% and about 1%, about 1% and about 20%, about 1% and about 15%, about 1% and about 10%, about 1% and about 5%, about 1% and about 2%, about 2% and about 20%, about 2% and about 15%, about 2% and about 10%, about 2% and about 5%, about 5% and about 20%, about 5% and about 15%, about 5% and about 10%, about 10% and about 20%, about 10% and about 15%, or about 15% and 20%.

In some embodiments, the inkjet composition comprising microparticles or a microparticle composition described herein is used in the formulation of an electronic device. In some embodiments, the inkjet composition comprising a microparticle or a microparticle composition described herein is used in the formulation of an electronic device selected from the group consisting of a nanostructure film, a display device, a lighting device, a backlight unit, a color filter, a surface light-emitting device, an electrode, a magnetic memory device, and a battery. In some embodiments, the inkjet composition comprising a microparticle composition described herein is used in the formulation of a light-emitting device.

### EXAMPLES

The following examples are illustrative and non-limiting, of the products and methods described herein. Suitable modifications and adaptations of the variety of conditions, formulations, and other parameters normally encountered in the field and which are obvious to those skilled in the art in view of this disclosure are within the spirit and scope of the invention.

### Example 1

### Nanostructure Ligand Exchange Process

Development of silica microparticles include transfer of nanostructures from a nonpolar solvent into water by ligand exchange. The typical process involves following steps.
Potassium or tetramethyl ammonium salt of mercaptopropionic acid (MPA) was prepared by mixing potassium hydroxide or tetramethyl ammonium hydroxide to MPA.
DI water, MPA salt, and butanol were mixed with QD solution in toluene/heptane in a flask.
Heat the flask to 60° C. for 3 hours.
Kept the solution to allow phase separation of aqueous and organic layers.
Aqueous phase was separated and purified.

The water soluble nanostructures were then used for synthesis of QD-silica particles. Several processes were developed for synthesis of QD-silica particles.

### Example 2

### Process 1: Calcium Silicate Encapsulated QD Particles:

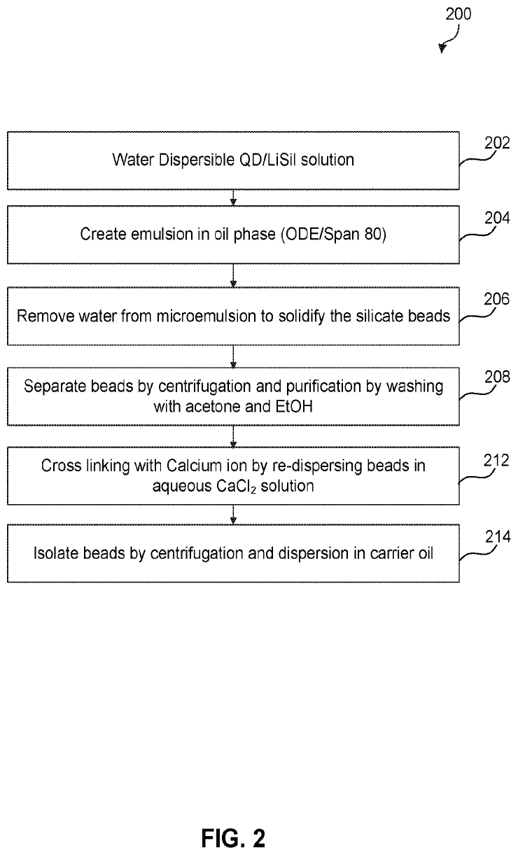

The typical process is summarized in FIG. 2. The details of the process are as follows
2 mL of aqueous dispersion of QD (9-10 wt % inorganic content)+3.4 mL of water+0.15 ml of (3-mercaptopropyl) trimethoxysilane (MPTMS) was stirred at 80° C. for 5 minutes.
2.8 mL of 25 wt. % lithium silicate (LiSil) solution was added with good stirring.
16.5 ml of 1.3 wt % Span® 80/octadecene (ODE) solution was added with good stirring. The solution became milky, indicating the formation of a microemulsion.
The emulsion was passed 3-4 times through a 6 micron filter for homogenization.
The water was removed from microemulsion by heating at 80° C. in vacuum. It takes around 10-15 min at 10 Torr vacuum.
The microparticles were separated by centrifugation (3000-4000 rpm for 5 minute).
The particles were purified with two acetone and two ethanol washes.
The QD-silicate particles were dispersed in 7 ml of 1M calcium chloride solution and stirred for 30 minutes at 60° C.
The product was isolated by centrifugation and purified by washing with ethanol (2 times).
The resultant product was dried to make powder and dispersed in a carrier solvent.
This process yields ˜95% of calcium silicate particles/batch with ˜20 wt % QD loading.

The process yields a fine powder of nanostructure-containing calcium silicate microparticles. In one embodiment, nanostructure-containing silicate particles consisted of red and green quantum dots when exposed to white and blue light. As expected, green and red fluorescence emission was observed when exposed to blue light that indicates the presence of quantum dot in the silicate particles.

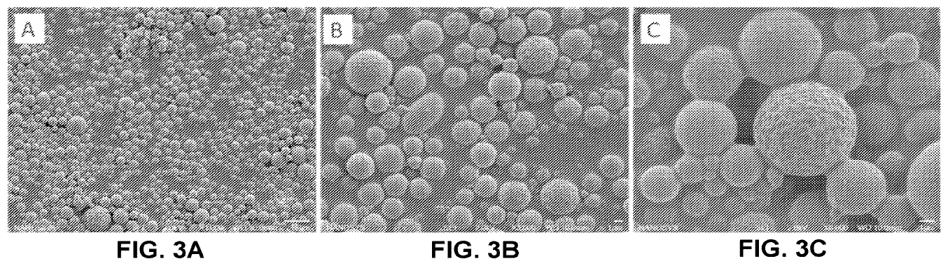

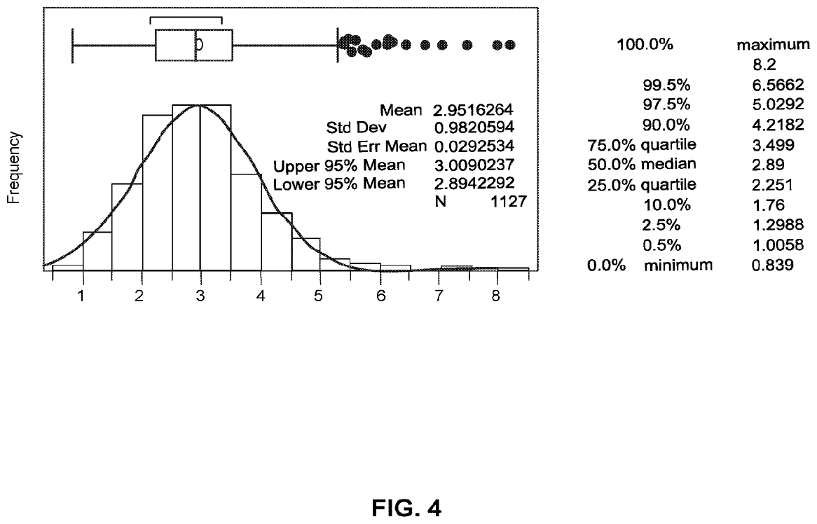

The microparticles were further characterized by scanning electron microscopy (SEM). FIGS. 3A-3C are SEM images of drop coated film of nanostructure-containing calcium silicate particles on a substrate. These particles were found to be well defined, uniform with rough surface topology. The particles size was measured from this image. The mean particles size was found to be 2.9±0.9 μm (FIG. 4).

A test specimen of quantum dot enhancement film (QDEF) was fabricated using poly(methyl methacrylate) (PMMA) and quantum dot-containing calcium silicate microparticles to study the stability/reliability of the particles under operating conditions. In a typical process, 1.5 gm of QD-silicate particles were mixed with the minimum amount of IBOA to make a paste. ˜15 gm of PMMA pellets were added to the paste and mixed well to make a homogeneous mixture and sheets were fabricated using an extruder. The stability of the QD-silicate microparticles was evaluated by monitoring the emission power from the sheet as a function of time under following conditions.
1) Under high flux (1, 10 and 68X) at 50° C.
2) Under accelerating condition under high flux (1 and 10X) at 80° C.
3) Under dark storage at 85° C.
4) Under storage at 60° C. and 90% relative humidity

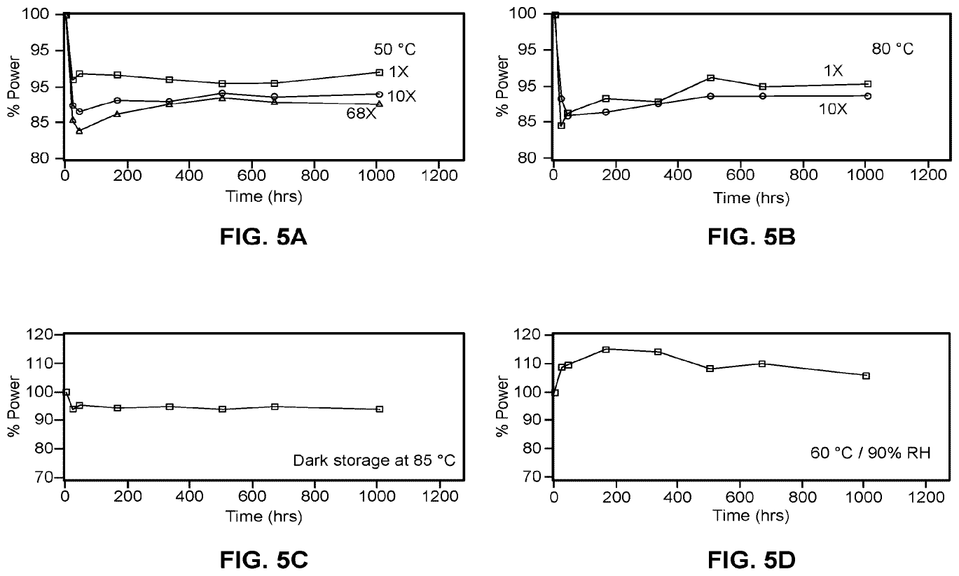

FIGS. 5A-5D shows the emitted power from the sheet over a 1000-hour period. The sheet was found to retain around 90% emission power under 1X &10X flux at 50° C. (FIG. 5A) and 80° C. (FIG. 5B), indicating satisfactory stability/reliability of film. However, the stability of the film was found to be insufficient in very aggressive conditions (68x flux at 50° C.; FIG. 5A). Also, no significant change was observed in emission power of the sheet for dark storage at 85° C. (FIG. 5C) as well as storage at 60° C./90% relative humidity (FIG. 5D). This indicates that the QDEF has good stability under most conditions tested.

### Example 3

### Process 2: Calcium Silicate Encapsulated QD Microparticles:

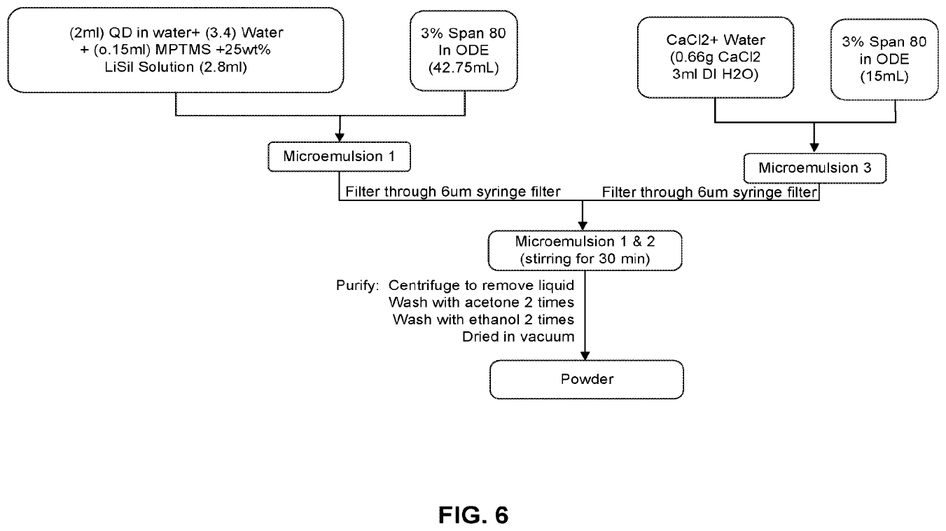

In another approach, QD-silicate microparticles were synthesized by directed crosslinking of silicate ion using Ca++ion in a microemulsion. The process flow is shown in FIG. 6.

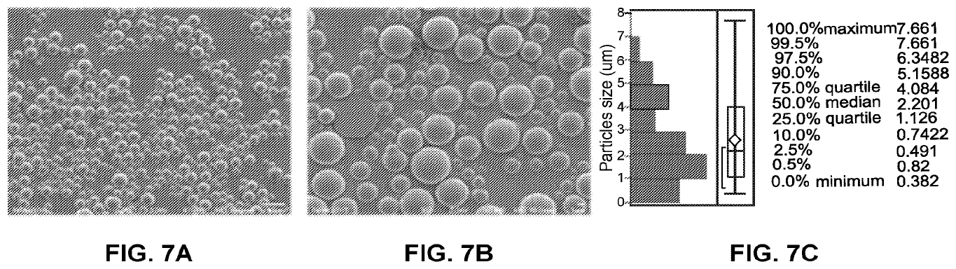

The details of the process are as follows
16.5 ml of 3 wt % Span® 80/ODE solution was stirred at 600 rpm. 2.8 mL of 25 wt. % lithium silicate solution was added with good stirring. The resultant mixture became milky, indicating the formation of a microemulsion.
This solution was passed through a 6 μm filter for homogenization. This solution was called “Microemulsion 1”.
2 mL of aqueous dispersion of QD (9-10 wt % inorganic content)+3.4 mL of water+0.15 ml of MPTMS was stirred at 60° C. for 5 minutes.
27.5 ml of 3 wt % Span® 80/ODE solution was stirred at 600 rpm. The above QD solution was added drop-by-drop. The resultant mixture became milky, indicating the formation of a microemulsion.
This solution was also passed through the 6 μm filter for homogenization. This solution is called “Microemulsion 2”.
Microemulsion 1 and 2 were mixed and kept for 30 min under stirring conditions.
15 ml of 3 wt % Span® 80/ODE solution was stirred at 600 rpm. 3 ml of 2M calcium chloride solution was added drop-by-drop. The resultant mixture become milky, indicate the formation of a microemulsion.
This solution was passed through a 6-micron filter for homogenization. This solution is called Microemulsion 3.
Finally, microemulsion 3 was added into mixture of microemulsion 1 &2 and the resultant mixture was kept for 30 min under stirring for silicate precipitation.
Finally, the particles were isolated by centrifugation and purified by acetone and ethanol wash.
The powder was dried and stored in carrier solvent.
The microparticles were characterized by scanning electron microscopy (FIGS. 7A and 7B). The QD-calcium silicate particles were spherical with a smooth surface texture. The size of the particles was found to be from submicron to 8-micron range (FIG. 7C).

### Example 4

### Process 3: Silica Encapsulated QD Microparticles:

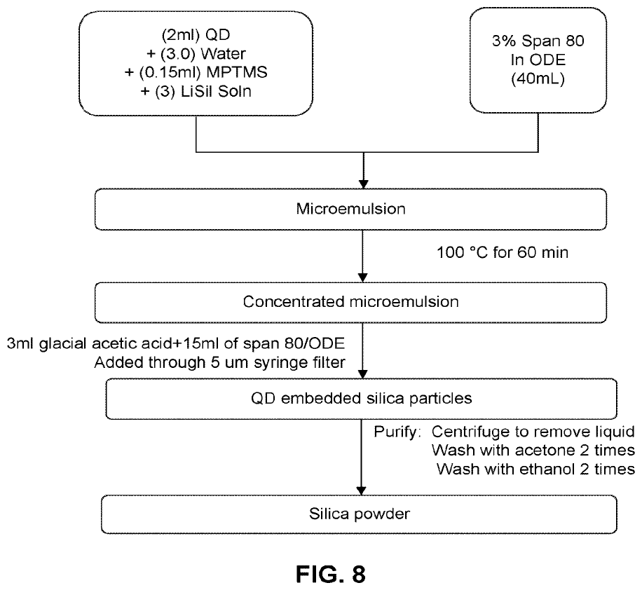

The typical process is summarized in FIG. 8. The details of the process are as follows
3 ml of water was added in 2 ml of QD solution and the resultant solution was heated to 60° C.
In the above solution, 0.15 ml of MPTMS was added and the solution was kept at 60° C. for 5 minute under stirring conditions (500 rpm).
To this solution, 3 ml of LiSil solution was mixed under stirring for 10 min.
In next step, a microemulsion was made by adding 24 ml of Span® 80/ODE (3 wt %) into QD/LiSil solution and the microemulsion was homogenized by passing through a 5 μm syringe filter.
The water was removed from the homogenized microemulsion by heating it in open air at 100° C. for 60 minutes under stirring condition (500-750 rpm range).
Acetic acid microemulsion was prepared by mixing 3 ml glacial acetic acid in 15 ml ODE/Span® 80 (3 wt %) and homogenized by passing through a 5 μm filter. This microemulsion was added in the above microemulsion.
The resultant microemulsion was kept at 100° C. for another 45 minutes for completion of condensation reaction.
Finally, the microparticles were isolated by centrifugation and purified by acetone and ethanol wash.
The silica powder was dried and stored in carrier solvent.

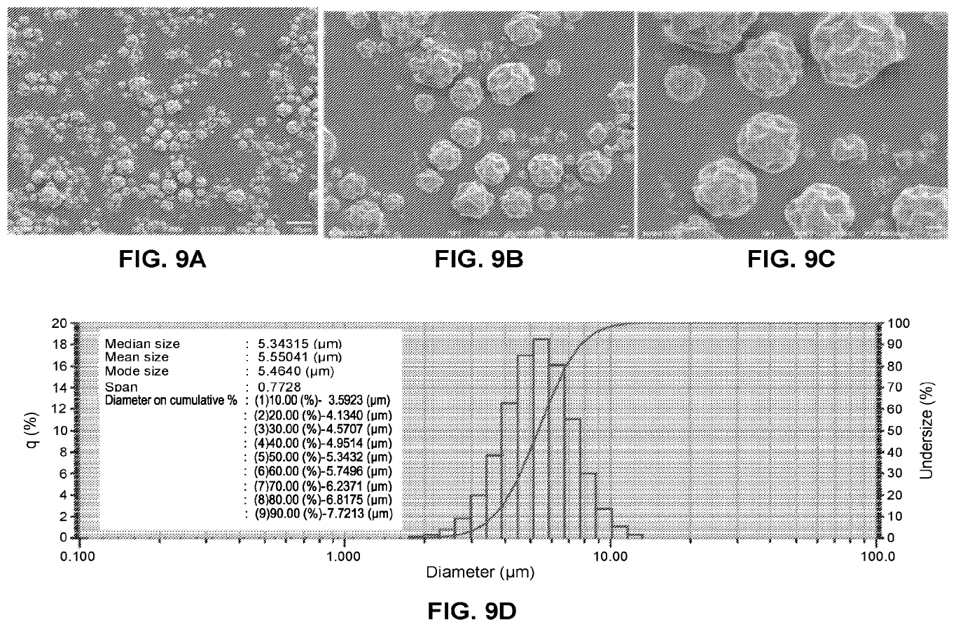

SEM was used to characterize the QD-silica particles (FIGS. 9A-9D). The QD-silica particles were found to have very rough surface texture (FIGS. 9A-9C) with the size in the range of 0.5-to-12-micron range (FIG. 9D).

Based upon the input materials, this process is expected to yield ˜20 wt % quantum dot loading in the QD-silica particles. The surface area of the silica particles and pore size was analyzed by BET isotherm (Table 1). The surface area was found to be ˜39.36 m²/gm with 30 nm pore size and 0.34 cm³/g pore volume (Table 1).

TABLE 1

| | BJH Pore Volume | BJH Pore Diameter |
|---|---|---|
| BET Specific Surface Area | (1.7-300 mn) | (1.7-300 nm) |
| (m²/g) | (cm³/g) | (nm) |
| 39.36 | 0.341 | 31.362 |

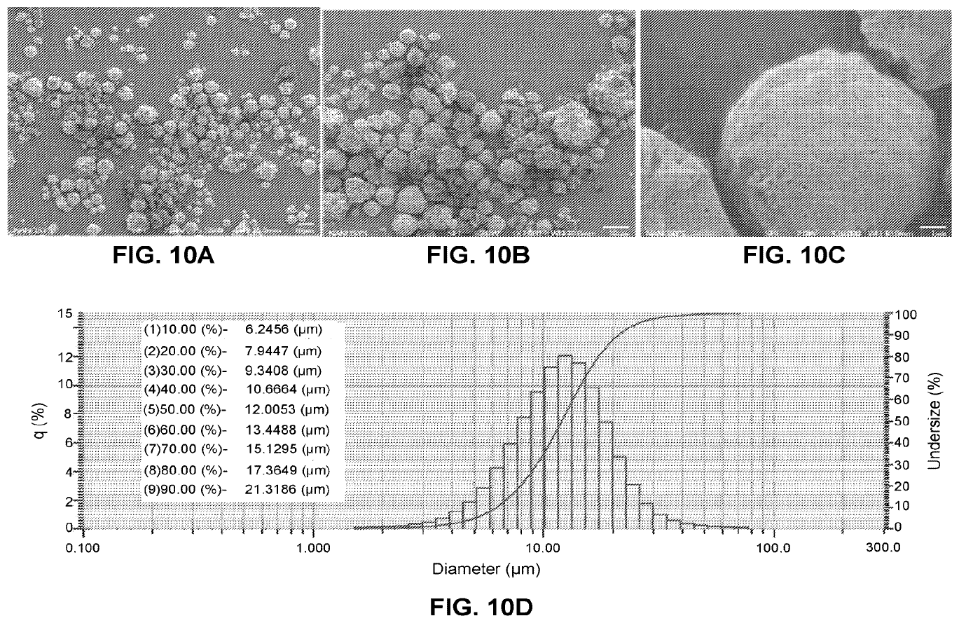

Quantum dot loading can be decreased by increasing the amount of LiSil solution. (FIGS. 10A-10D). In the next step, the QD loading in silica particles was reduced by increasing the lithium silicate. In this process, the QD loading is expected to be ˜10 wt % in the silica particles.

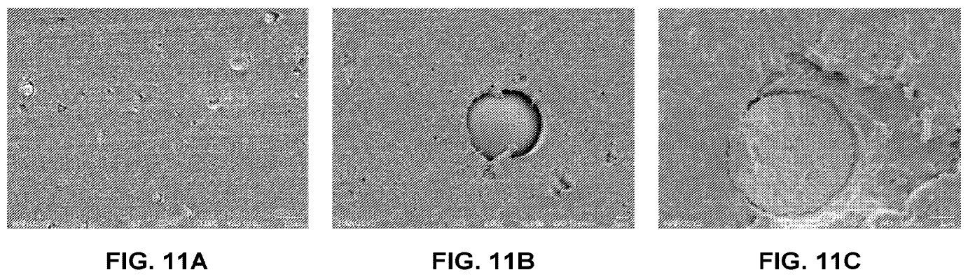

The QD-silica particles were found to be well defined with visible pores on the surface (FIG. 11). The size of the particles was found to be in the range of 6-22 μm range in this case.

A test specimen of Quantum dot enhancement film (QDEF) was fabricated using PMMA and QD-silica particles to study the stability or reliability of the particles under operating conditions. In a typical process, 1.5 gm of QD-silica particles were mixed with the minimum amount of IBOA to make a paste. ˜15 gm of PMMA pellets were added to the paste and mixed well to make a homogeneous mixture and sheets were fabricated using an extruder. The sheet was analyzed using SEM to visualize the distribution of particles in the PMMA matrix as well as any morphological change due to extrusion. FIGS. 11A-11C are SEM images of the cross-section of the extruded sheet, showing uniform distribution of particles in the film. The QD-silica particles were found to be intact after extrusion, indicating their robustness and stability.

The stability of the QD-silica particles was evaluated by monitoring the emission power from the sheet as a function of time under following conditions.
Under high flux (1, 10 and 68X) at 50° C.
Under accelerating conditions under high flux (1 and 10X) at 80° C.
Under dark storage at 85° C.
Under storage at 60° C. and 90% relative humidity

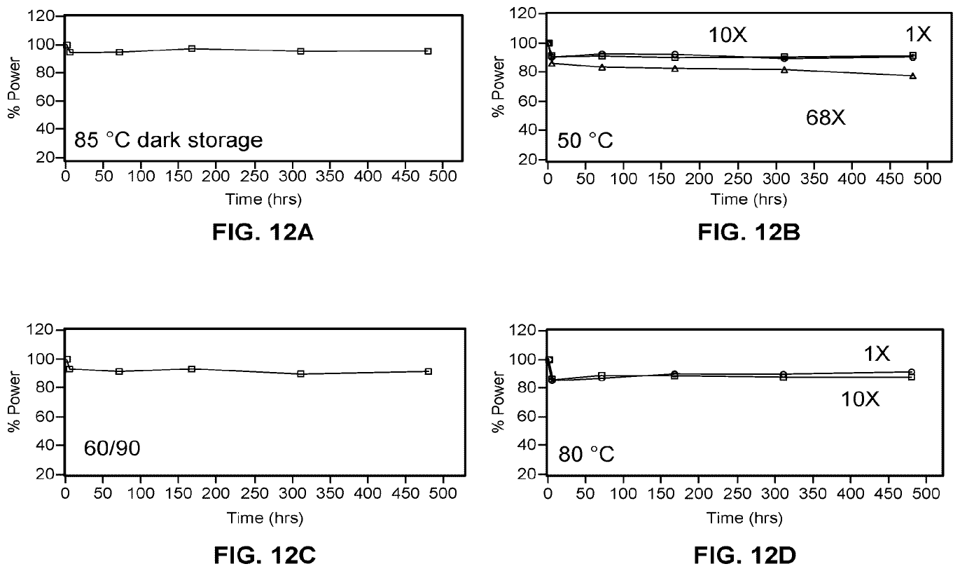

FIGS. 12A-12D show the emitted power from the sheet over a 500-hour period. The sheet was found to retain more than 90% emission power under 1 & 10 X flux at 50° C. (FIG. 12B) as well as 1X flux at 80° C. (FIG. 12D), indicating its satisfactory stability/reliability as per product requirement. However, the stability of the film was found to be insufficient in very aggressive conditions (68x flux at 50 C (FIG. 12B) & 10X at 80 C (FIG. 12D)). Also, no significant change was observed in emission power of the sheet for dark storage at 85° C. (FIG. 12A) as well as storage at 60° C./90% relative humidity (FIG. 12C). This indicate that the QDEF film exhibited good stability.

### Example 5

### Process 4: Calcium Silicate Encapsulated QD Microparticles:

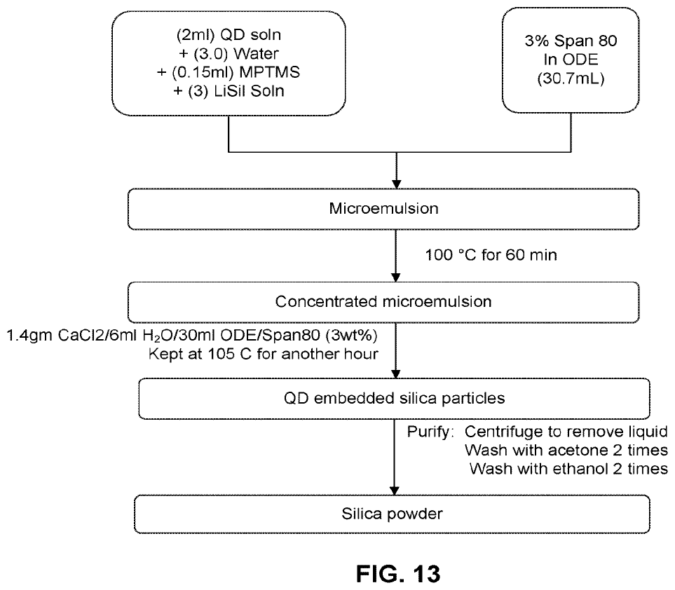

The typical process is summarized in FIG. 13. The details of the process are as follows:
3 ml of water was added in 2 ml of QD solution and the resultant solution was heated to 60° C.
In the above solution, 0.15 ml of MPTMS was added and the solution was kept at 60° C. for 5 minute under stirring conditions (500 rpm).
To this solution 3 ml of LiSil solution was mixed under stirring for 10 min.
In next step, a microemulsion was made by adding 24 ml of Span® 80/ODE (3 wt %) into the QD/LiSil solution and the microemulsion was homogenized by passing through a 5 μm syringe filter.
The water was removed from the homogenized microemulsion by heating it in open air at 100° C. for 60 minutes under stirring conditions (500-750 rpm range).
1.4 gm of calcium chloride was dissolved in 6 ml of water. The microemulsion was prepared by mixing calcium chloride solution in 24 ml ODE/Span® 80 (3 wt %) and homogenized by passing through a 5 μm filter. This microemulsion was added to the above microemulsion.
The resultant microemulsion was kept at 100° C. for another 45 minutes for completion of cross-linking reaction.
Finally, the particles were isolated by centrifugation and purified by acetone and ethanol wash.
The powder was dried and stored in carrier solvent.

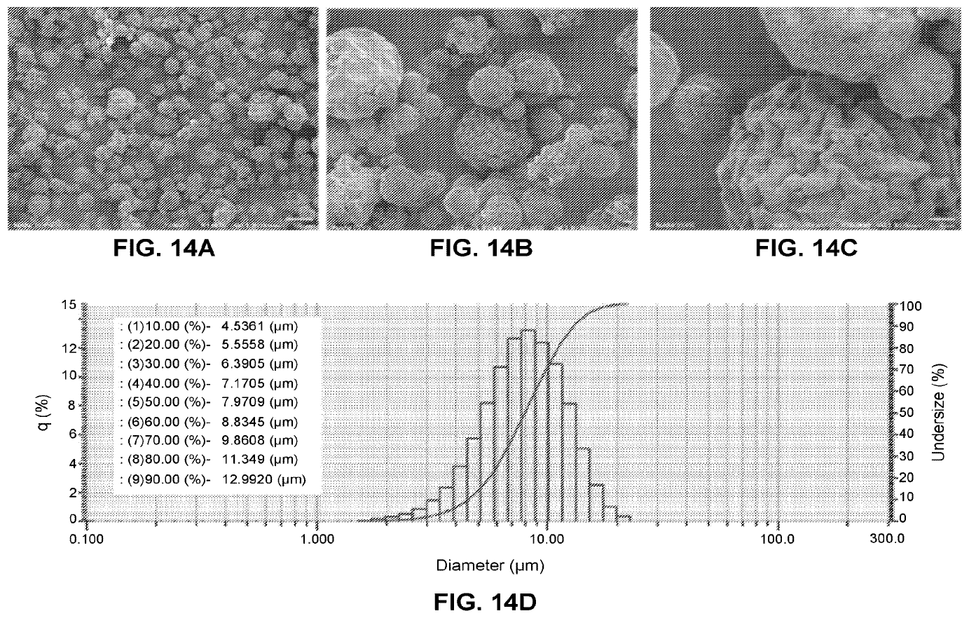

Scanning electron microscopy was used to characterize the QD-calcium silicate particles as shown in FIGS. 14A-14D. The QD-calcium silicate particles were found to have very rough surface texture (FIGS. 14A-14C) with the size in the range of 4-to-15-micron range (FIG. 14D).

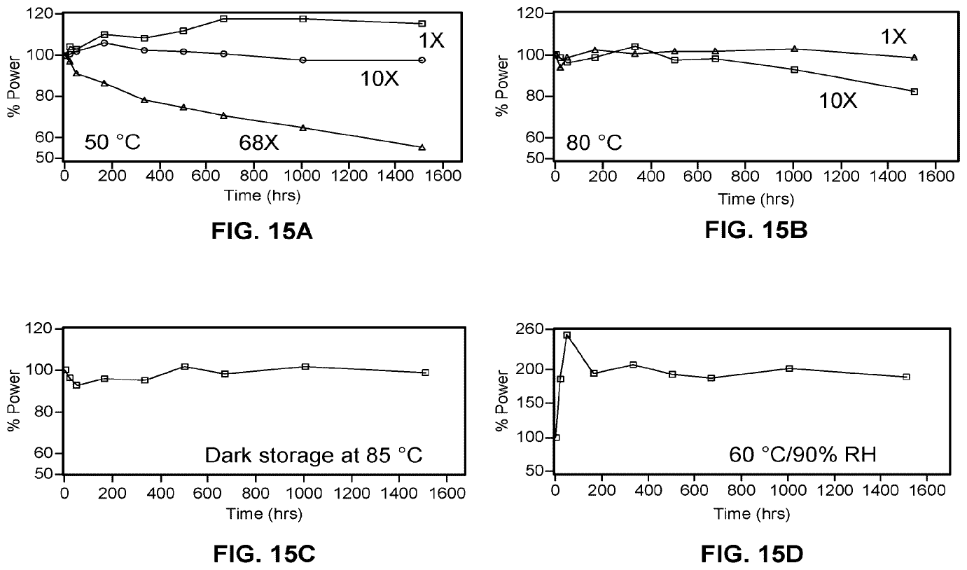

FIGS. 15A-15D show the emitted power from the sheet over a 1600-hour period. The sheet was found to retain more than 90% emission power under 1 & 10 X flux at 50° C. (FIG. 15A) as well as 1X flux at 80° C. (FIG. 15B), indicating its satisfactory stability/reliability. However, the stability of the film was found to be insufficient in very aggressive conditions (68x flux at 50° C. (FIG. 15A) & 10X at 80° C. (FIG. 15B)). Also, no significant change was observed in emission power of the sheet for dark storage at 85° C. (FIG. 15C) as well as storage at 60° C./90% relative humidity (FIG. 15D). This indicate that the QDEF had good stability.

### Example 6

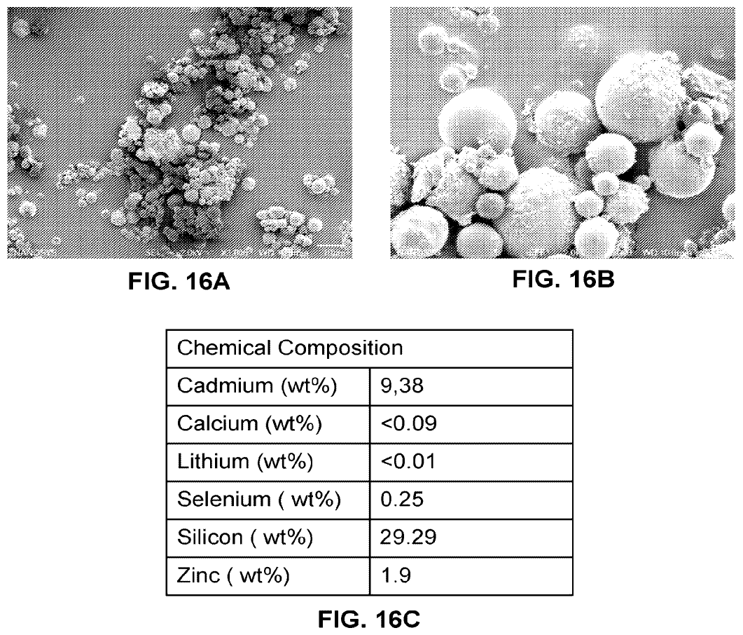

This example provides silica containing microparticles from ammonium silicate in place of lithium silicate in Example 4. As shown in FIGS. 16A and 16B, microparticles of various sizes ranging from submicron to about 10 μm were obtained. As shown in FIG. 16C, the composition of the nanoparticles consisted of CdSe/ZnSe nanostructures and silica.

### Example 7

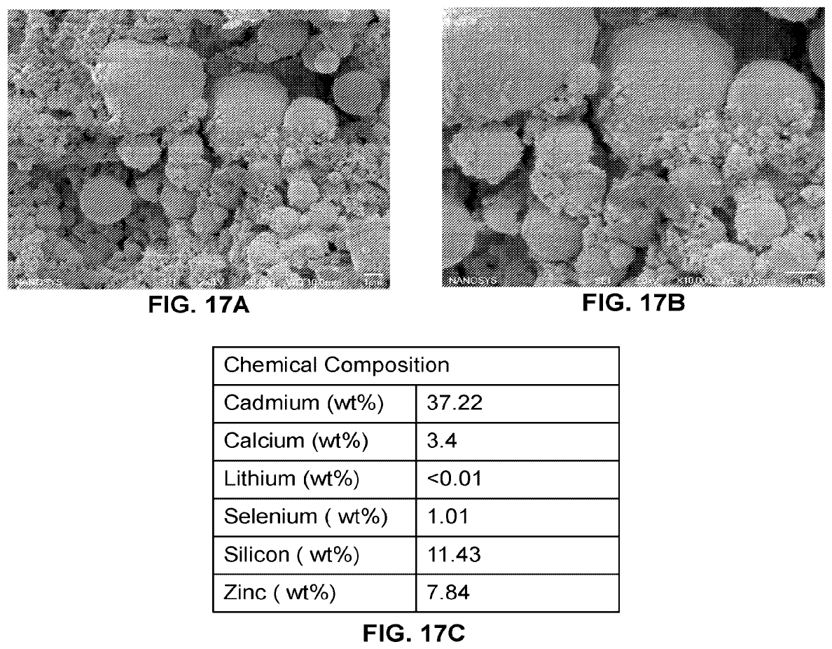

This example provides silica-containing microparticles from ammonium silicate using an emulsion process. As shown in FIGS. 17A and 17B, microparticles of various sizes ranging from submicron to about 10 μm were obtained. As shown in FIG. 17C, the composition of the nanoparticles consisted of CdSe/ZnSe nanostructures and calcium silicate.

### Example 8

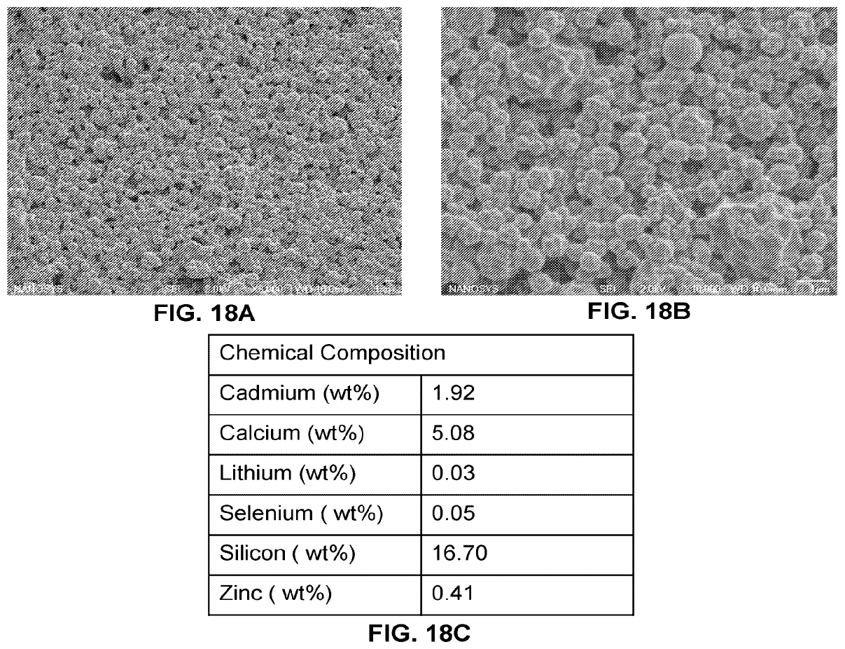

This example provides silicate-containing microparticles from lithium silicate using an emulsion process. As shown in FIGS. 18A and 18B, microparticles of various sizes ranging from submicron to about 6 μm were obtained. As shown in FIG. 18C, the composition of the nanoparticles consisted of CdSe/ZnSe nanostructures and calcium silicate.

While various embodiments have been described above, it should be understood that they have been presented by way of example only, and not limitation. It will be apparent to persons skilled in the relevant art that various changes in form and detail can be made therein without departing from the spirit and scope of the invention. Thus, the breadth and scope should not be limited by any of the above-described exemplary embodiments, but should be defined only in accordance with the following claims and their equivalents.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

1-10. (canceled)

11. A method of making a composition of comprising:
(a) admixing nanostructures and a metal or ammonium silicate in water, the nanostructures comprising a nanocrystal core;
(b) adding the admixture obtained in (a) to a solution comprising a nonionic surfactant in a nonpolar aprotic solvent and mixing to give a first microemulsion;
(c) removing water from the first microemulsion obtained in (b);
(d) admixing acetic acid, a nonionic surfactant and a nonpolar aprotic solvent to give a second microemulsion;
(e) admixing the first and second microemulsions to give silica microparticles comprising the nanostructures; and
(f) isolating the silica microparticles obtained in (e).

12. The method of claim 11, wherein the first and second microemulsions are passed through a filter with pores of less than 10 μm prior to admixing in (e).

13. The method of claim 11, wherein the non-polar aprotic solvent comprises 1-octadecene, 1-hexadecene, 1-eicosene, eicosane, octadecane, hexadecane, tetradecane, squalene, or squalane, or combinations thereof.

14. The method of claim 13, wherein the non-polar aprotic solvent comprises 1-octadecene.

15. A nanostructure film comprising:
(a) a composition comprising a population of nanostructures comprising a nanocrystal core, wherein the nanostructures are embedded in silica microparticles; and
(b) at least one organic resin.

16. The nanostructure film of claim 15, wherein the microparticles are embedded in the at least one organic resin that form the nanostructure film.

17. The nanostructure film of claim 15, wherein the nanostructure film is cured.

18. The nanostructure film of claim 15, wherein the nanostructure film is formed by extrusion.

19. The nanostructure film of claim 15, wherein the nanostructure film does not comprise a barrier layer that has low oxygen and moisture permeability adjacent to the nanostructure film.

20. A nanostructure molded article comprising:
(a) a first conductive layer;
(b) a second conductive layer; and
(c) a nanostructure layer between the first conductive layer and the second conductive layer, wherein the nanostructure layer comprises a composition comprising a population of nanostructures comprising a nanocrystal core, wherein the nanostructures are embedded in silica microparticles.

21. The nanostructure molded article of claim 20, wherein the nanostructure molded article does not comprise a barrier layer that has low oxygen and moisture permeability adjacent to the nanostructure layer.

22. A display device comprising the nanostructure molded article claim 20.

23. The display device of claim 22, wherein the silica microparticles are embedded in a matrix that forms a film within the display device.

24. The display device of claim 23, wherein the film is disposed on a light guide plate.

25. The display device of claim 23, wherein the display device does not comprise a barrier layer that has low oxygen and moisture permeability adjacent to the film.

26-37. (canceled)

38. The nanostructure film of claim 15, wherein the nanocrystal core is selected from the group consisting of Si, Ge, Sn, Se, Te, B, C, P, BN, BP, BAS, AlN, AlP, AlAs, AlSb, GaN, GaP, GaAs, GaSb, InN, InP, InAs, InSb, ZnO, ZnS, ZnSe, ZnTe, CdS, CdSe, CdSeZn, CdTe, HgS, HgSe, HgTe, Bes, BeSe, BeTe, MgS, MgSe, GeS, GeSe, GeTe, SnS, SnSe, SnTe, PbO, PbS, PbSe, PbTe, CuF, CuCl, CuBr, CuI, Si₃N₄, Ge₃N₄, Al₂O₃, Al₂CO, AgInGaS and combinations thereof.

39. The nanostructure film of claim 15, wherein the silica microparticles have diameters of about 1 μm to about 20 μm.
